(19) United States
(12) Patent Application Publication
(10) Pub. No.: US 2026/0247381 A1
(43) Pub. Date: Aug. 20, 2026

(54) COMMUNICATION METHOD AND APPARATUS USING IMPROVED REPEATER IN WIRELESS COMMUNICATION SYSTEM

(71) Applicant: ELECTRONICS AND TELECOMMUNICATIONS RESEARCH INSTITUTE, Daejeon (KR)

(72) Inventor: Ji Hyung KIM, Daejeon (KR)

(73) Assignee: ELECTRONICS AND TELECOMMUNICATIONS RESEARCH INSTITUTE, Daejeon (KR)

(21) Appl. No.: 18/878,964

(22) PCT Filed: Jul. 27, 2023
(86) PCT No.: PCT/KR2023/010915

§ 371 Date: Dec. 26, 2024

(30) Foreign Application Priority Data
Jul. 28, 2022 (KR) 10-2022-0093844

(51) Int. Cl. H04W 72/20; H04B 7/04; H04B 7/06; H04W 76/28

(52) U.S. Cl. CPC H04W 72/20; H04B 7/04013; H04B 7/0617; H04W 76/28

(57) ABSTRACT

The present disclosure provides a communication method and apparatus using an improved repeater, such as NCR, RIS, or the like, which can be applied in a wireless communication system. The communication method for a repeater in a wireless communication system, according to an embodiment of the present disclosure, may comprise the steps of obtaining control information from a network node and controlling the repeater on the basis of the control information.

### TECHNICAL FIELD

The present disclosure relates to wireless communication, and more particularly, to a communication method and apparatus using an enhanced repeater in a wireless communication system.

### BACKGROUND ART

As more communication devices require a larger communication capacity, there is a growing need for enhanced mobile broadband communication compared to existing radio access technology (RAT). Massive machine type communications (MTC) connecting a number of devices and objects to provide a variety of services at any time and any place is one major issue to be considered in next-generation communication. In addition, communication system design considering services/terminals sensitive to reliability and latency is being discussed. The introduction of next-generation RAT considering such enhanced mobile broadband communication, massive MTC, ultra-reliable and low-latency communication (URLLC), and the like is being discussed. For convenience of description, the next-generation RAT will be referred to herein as new RAT or NR.

New types of network nodes have been considered to increase flexibility in building a network by mobile carriers. For example, an integrated access and backhaul (IAB), new types of network nodes that do not need a wired backhaul, and the like have been considered. As another type of network node, there is a radio-frequency (RF) repeater that simply amplifies and delivers all received signals. RF repeaters have been widely deployed to supplement coverage provided by general full stack cells. RF and electromagnetic compatibility (EMC) requirements for RF repeaters for NR targeting both frequency range 1 (FR1) and FR2 may be required.

Meanwhile, an intelligent reflecting surface (IRS) has attracted attention as a relay node performing functions similar to those of a repeater. The IRS is a planar surface with passive elements formed of a metamaterial (hereinafter referred to as IRS elements), in which a phase of a received signal is changed by the IRS elements to form beams in a desired shape and reflect or pass a received signal to which the formed beams are applied. The IRS may also be referred to as a reconfigurable intelligent surface (RIS) or the like. Hereinafter, RIS and IRS may be used interchangeably.

### DISCLOSURE

### Technical Problem

Embodiments of the present disclosure provide a communication method and apparatus using an enhanced repeater to improve coverage in a communication system.

### Technical Solution

A communication method of a repeater in a wireless communication system, according to an embodiment of the present disclosure, may comprise: receiving control information from a network node; and controlling the repeater on the basis of the control information.

Here, the control information may comprise control information about at least some elements of the repeater, and the control information for the at least some elements of the repeater may comprise at least one of information about a configuration of at least one of regions of the elements or a set or group of the elements or information about a function of the regions or the set or group.

Here, the controlling of the repeater may comprise at least one of controlling the repeater to be powered on and/or off, controlling an antenna or form of the repeater, beamforming, giving a report to the base station, transmitting control information for a user equipment (UE), or configuring regions or a set of elements of the repeater.

Here, the controlling of the repeater to be powered off may comprise maintaining a minimum amount of power necessary to monitor reception of the control information. In addition, the controlling of the repeater to be powered on and/or off may be performed on the basis of discontinuous reception (DRX).

Meanwhile, the control information may be transmitted periodically, quasi-periodically, or aperiodically. In addition, the control information may comprise an explicit command or an implicit command.

Here, the repeater may comprise a network-controlled repeater (NCR) or a reconfigurable intelligent surface (RIS).

A repeater apparatus for performing communication in a wireless communication system, according to an embodiment of the present disclosure, may comprise: a transceiver configured to obtain control information from a network node; and a processor configured to control the repeater on the basis of the control information.

Here, the control information may comprise control information about at least some elements of the repeater, and the control information for the at least some elements of the repeater may comprise at least one of information about a configuration of regions of the elements or a set or group of the elements or information about a function of the regions or the set or group.

Here, the processor may control the repeater according to at least one of controlling the repeater to be powered on and/or off, controlling an antenna or form of the repeater, beamforming, giving a report to the base station, transmitting control information for a user equipment (UE), or configuring regions or a set of elements of the repeater.

In a computer-readable recording medium having recorded thereon a program causing a computer to execute operations of a communication method of a repeater in a wireless communication system, according to an embodiment of the present disclosure, the communication method of the repeater may comprise: receiving control information from a network node; and controlling the repeater on the basis of the control information.

### Advantageous Effects

According to the present disclosure, communication is performed using an enhanced repeater applicable to next-generation wireless communication systems such as a network controlled repeater (NCR) and a reconfigurable intelligent surface (RIS) to improve relay performance of repeaters, reduce signaling overhead through an improved control method, and increase communication efficiency.

### DESCRIPTION OF DRAWINGS

The following drawings have been prepared to describe concrete examples of the present disclosure. The names of the devices or specific signals/messages/fields illustrated in the drawings are provided as examples and thus the technical features of the present disclosure are not limited thereby.

FIG. 1 illustrates a wireless communication system to which the present disclosure is applicable.

FIG. 2 is a block diagram illustrating a radio protocol architecture for a user plane.

FIG. 3 is a block diagram illustrating a radio protocol architecture for a control plane.

FIG. 4 is a diagram illustrating another example of a wireless communication system to which embodiments of the present disclosure are applicable.

FIG. 5 is a diagram illustrating functional division between NG-RAN and 5GC.

FIG. 6 is a diagram illustrating a frame structure applicable to NR.

FIG. 7 is a diagram illustrating a slot structure of NR.

FIG. 8 is a diagram schematically illustrating an example of a network with integrated access and backhaul links (IAB).

FIG. 9 is a diagram illustrating an example of an operation of an IAB system in a standalone (SA) mode and a non-standalone (NSA) mode.

FIG. 10 is a diagram schematically illustrating an example of configurations of access and backhaul links in NR.

FIG. 11 is a diagram illustrating links and relationships between IAB nodes in NR.

FIG. 12 is a diagram illustrating an example of a conceptual model of a network control repeater in NR.

FIG. 13 is a diagram illustrating an embodiment of the present disclosure, in which a repeater is located within cell coverage of a base station and a UE is located outside the cell coverage of the base station.

FIG. 14 is a diagram illustrating an embodiment of the present disclosure, in which a repeater and a UE are located within cell coverage of a base station.

FIG. 15 is a diagram illustrating an embodiment of the present disclosure, in which a first repeater is located within cell coverage of a base station, a second repeater is located outside the cell coverage, and a UE connected to the second repeater is located outside the cell coverage.

FIG. 16 is a diagram illustrating a structure or form of an antenna of a repeater according to an embodiment of the present disclosure.

FIG. 17 is a diagram illustrating an example of a control module of a repeater according to an embodiment of the present disclosure.

FIG. 18 is a diagram illustrating an example in which the idle mode DRX operation is performed in relation to the power-on operation and/or the power-off operation of the present disclosure.

FIG. 19 is a diagram illustrating a DRX cycle in relation to a power-on operation and/or a power-off operation of the present disclosure.

FIG. 20 is a diagram illustrating an example of an operating method of a repeater according to some embodiments of the present disclosure.

FIG. 21 is a diagram illustrating some of protocol layers of a base station, a repeater, and a UE according to an embodiment of the present disclosure.

FIG. 22 is a sequence chart of a procedure for transmitting function/capability information of a repeater according to an embodiment of the present disclosure.

FIG. 23 is a sequence chart of an example of a control signaling procedure of a repeater according to an embodiment of the present disclosure.

FIG. 24 is a diagram illustrating an example of a MAC-CE applicable to the technical features proposed in the present disclosure.

FIG. 25 is a diagram illustrating an example of a DCI applicable to the technical features proposed in the present disclosure.

FIG. 26 is a diagram illustrating examples of a wireless device applicable to the present disclosure.

### MODE FOR INVENTION

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

A technical feature described individually in one figure in the present specification may be individually implemented, or may be simultaneously implemented.

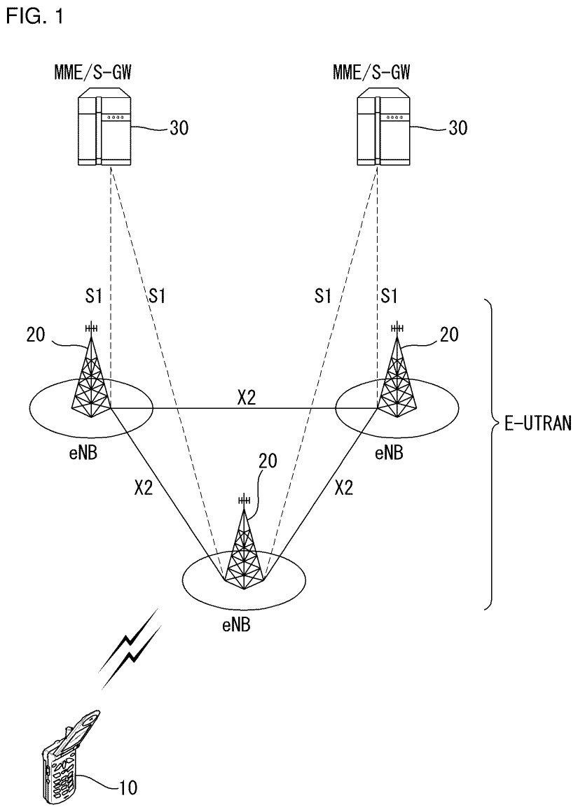

FIG. 1 illustrates a wireless communication system to which the present disclosure is applicable. The wireless communication system may also be referred to as an evolved-UMTS terrestrial radio access network (E-UTRAN) or a long-term evolution (LTE)/LTE-A system.

An E-UTRAN includes a base station (BS) 20 that provides a control plane and a user plane to a user equipment (UE) 10. The UE 10 may be fixed or mobile and may be referred to by another term, e.g., “mobile station (MS),” “user terminal (UT),” “subscriber station (SS),” “mobile terminal (MT),” or “wireless device.” The BS 20 is a fixed station communicating with the UE 10 and may be referred to by another term, e.g., “evolved-NodeB (eNB),” “base transceiver system (BTS),” or “access point.”

BSs 20 may be connected to each other via an X2 interface. The BS 20 is connected to an evolved packet core (EPC) 30 through an S1 interface, and more specifically, to a mobility management entity (MME) through an S1-MME and a serving gateway (S-GW) through an S1-U.

The EPC 30 includes an MME, an S-GW, and a packet data network-gateway (P-GW). The MME stores access information or information about the capability of a UE, and the stored information is generally used for mobility management of the UE. The S-GW is a gateway having an E-UTRAN as an end point, and the P-GW is a gateway having a PDN as an end point.

Layers of a radio interface protocol between a UE and a network may be divided into a first layer L1, a second layer L2, and a third layer L3 on the basis of three lower layers of an open system interconnection (OSI) reference model well known in communication systems, wherein a physical layer belonging to the first layer provides an information transfer service using a physical channel, and a radio resource control (RRC) layer on the third layer controls radio resources between the UE and the network. To this end, the RRC layer exchanges RRC messages between the UE and a BS.

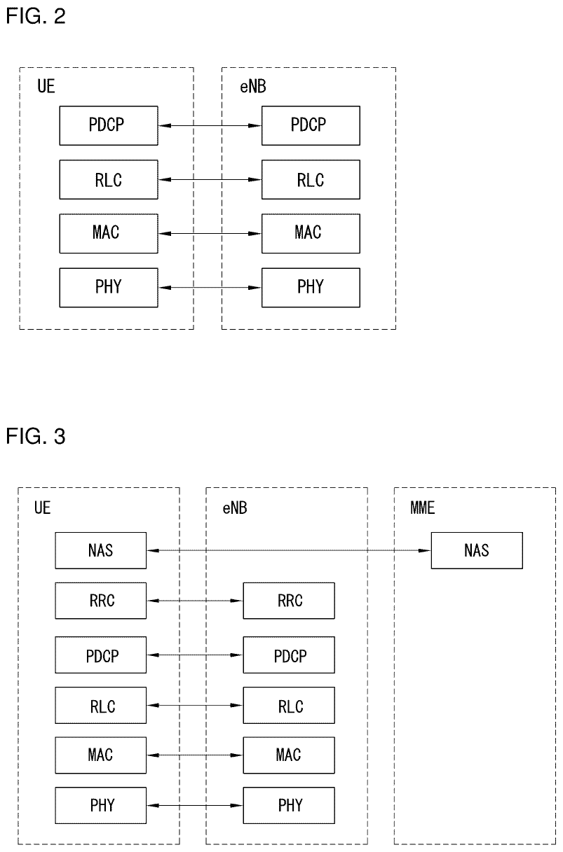

FIG. 2 is a block diagram illustrating a radio protocol architecture for a user plane. FIG. 3 is a block diagram illustrating a radio protocol architecture for a control plane. The user plane is a protocol stack for transmission of user data, and the control plane is a protocol stack for transmission of control signals.

Referring to FIGS. 2 and 3, a physical layer PHY provides a higher layer with an information transfer service using a physical channel. The physical layer PHY is connected to a medium access control (MAC) layer, which is a higher layer, through a transport channel. Data is transmitted between the MAC layer and the physical layer PHY through the transport channel. Transmission channels are classified according to methods and features of data transmission through a wireless interface.

Data is transferred between different physical layers, i.e., between physical layers of a transmitter and a receiver, through a physical channel. The physical channel may be modulated by an orthogonal frequency division multiplexing (OFDM) method, and time and frequency may be used as radio resources therefor.

Functions of the MAC layer include mapping between a logical channel and the transport channel, and multiplexing/demultiplexing to a transport block provided as the physical channel over a transport channel of a MAC service data unit (SDU) belonging to the logical channel. The MAC layer provides services to a radio link control (RLC) layer through the logical channel.

Functions of the RLC layer include concatenation, segmentation, and reassembly of an RLC SDU. The RLC layer provides three operation modes, i.e., a transparent mode (TM), an unacknowledged mode (UM), and an acknowledged mode (AM), to secure various qualities of service (QoSs) required by a radio bearer (RB). AM RLC provides error correction through an automatic repeat request (ARQ).

A radio resource control (RRC) layer is defined only with respect to the control plane. The RRC layer controls a logical channel, the transport channel, the physical channel, and the like in relation to a configuration, a re-configuration, and a release of RBs. An RB is a logical path provided by a first layer (a PHY layer) and second layers (an MAC layer, an RLC layer, and a packet data convergence protocol (PDCP) layer) for the transmission of data between a UE and a network.

Functions of the PDCP layer on the user plane include the transmission of user data, header compression, and ciphering. Functions of the PDCP layer on the control plane include the transmission of control plane data and ciphering/integrity protection.

The setting of the RB is a process of defining characteristics of a radio protocol layer and a channel to provide a specific service, and setting specific parameters and operating methods thereof. The RB may be divided into two types of RBs: a signaling RB (SRB) and a data RB (DRB). The SRB is used as a path for transmitting an RRC message on the control plane, and the DRB is used as a path for transmitting user data on the user plane.

A UE is in an RRC connected state when an RRC connection is established between an RRC layer of the UE and an RRC layer of an E-UTRAN, and is in an RRC idle state otherwise.

Examples of downlink transport channels for transmission of data to a UE from a network include a broadcast channel (BCH) for transmitting system information and a downlink shared channel (SCH) for transmitting user traffic or control messages. Transmission of traffic or control messages using downlink multicast or broadcast services may be performed through a downlink SCH or a separate downlink multicast channel (MCH). Meanwhile, examples of uplink transport channels for transmission of data from a UE to a network include a random access channel (RACH) for transmitting an initial control message and an uplink SCH for transmitting user traffic or control messages.

Examples of logical channels located on the transport channel and mapped to the transport channel include a broadcast control channel (BCCH), a paging control channel (PCCH), a common control channel (CCCH), a multicast control channel (MCCH), a multicast traffic channel (MTCH), etc.

A physical channel consists of several OFDM symbols in a time domain and several subcarriers in a frequency domain. One subframe includes a plurality of OFDM symbols in the time domain. A resource block is a resource allocation unit and includes a plurality of OFDM symbols and a plurality of sub-carriers. Certain subcarriers of certain OFDM symbols (e.g., a first OFDM symbol) of each subframe may be used for a physical downlink control channel (PDCCH), i.e., an L1/L2 control channel. A transmission time interval (TTI) is a transmission unit time and may be, for example, a subframe or a slot.

A new radio access technology (new RAT or NR) will be described below.

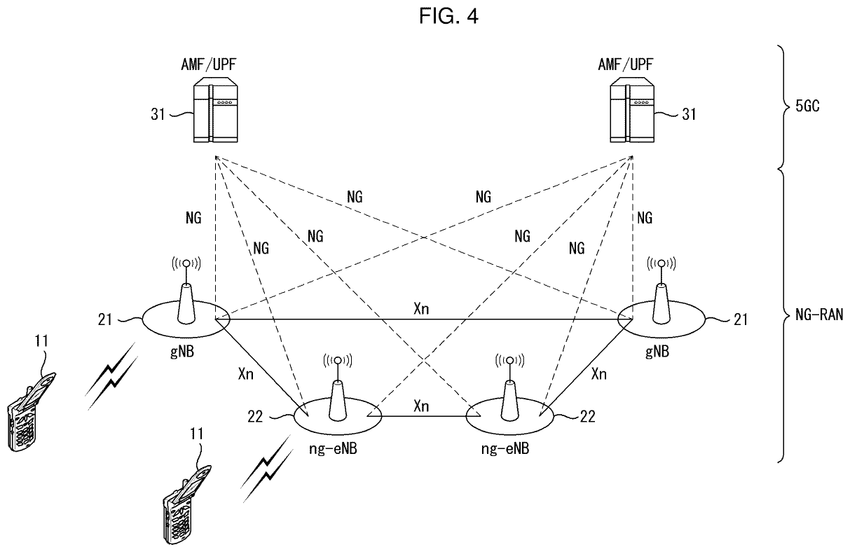

FIG. 4 is a diagram illustrating another example of a wireless communication system to which embodiments of the present disclosure are applicable.

Specifically, FIG. 4 illustrates a system architecture based on a 5G new radio access technology (NR) system. Entities used in the 5G NR (hereinafter referred to as simply as “NR”) system may absorb some or all of the functions of the entities introduced in FIG. 1 (e.g., eNB, MME, and S-GW). Entities used in the NR system may be identified by a name “NG” to distinguish them from LTE.

Referring to FIG. 4, a wireless communication system includes one or more UEs 11, a next-generation RAN (NG-RAN), and a fifth-generation core network (5GC). The NG-RAN includes at least one NG-RAN node. The NG-RAN node is an entity corresponding to the BS 20 illustrated in FIG. 1. The NG-RAN node includes at least one gNB 21 and/or at least one ng-eNB 22. The gNB 21 provides the termination of an NR user plane and a control plane protocol toward the UE 11. The Ng-eNB 22 provides the termination of an E-UTRA user plane and a control plane protocol toward the UE 11.

The 5GC includes an access and mobility management function (AMF), a user plane function (UPF), and a session management function (SMF). The AMF hosts functions such as NAS security and idle state mobility processing. The AMF is an entity including functions of a conventional MME. The UPF hosts functions such as mobility anchoring and protocol data unit (PDU) processing. The UPF is an entity including functions of a conventional S-GW. The SMF hosts functions such as UE IP address allocation and PDU session control.

The gNB and the ng-eNB are connected to each other through an Xn interface. The gNB and the ng-eNB are connected to the 5GC through an NG interface. More specifically, the gNB and the ng-eNB are connected to the AMF through an NG-C interface and to the UPF through an NG-U interface.

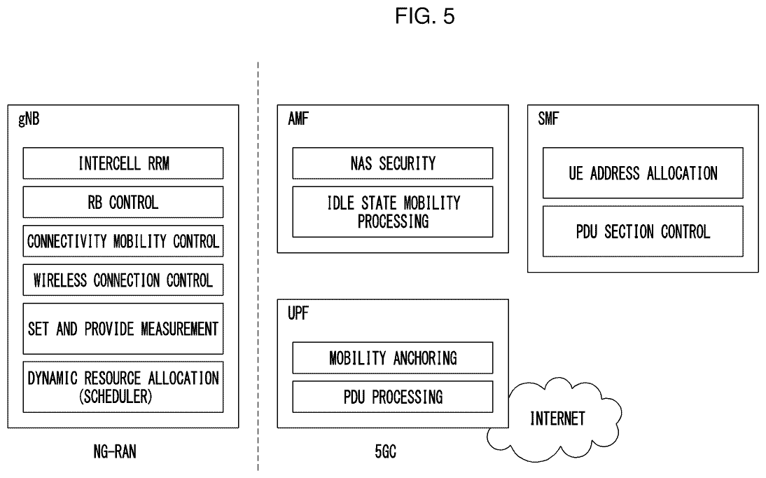

FIG. 5 is a diagram illustrating functional division between NG-RAN and 5GC.

Referring to FIG. 5, a gNB may provide functions such as inter-cell RRM, RB control, connection mobility control, radio admission control, measurement configuration & provision, and dynamic resource allocation. The AMF may provide functions such as NAS security and idle state mobility processing. The UPF may provide functions such as mobility anchoring and PDU processing. The session management function (SMF) may provide functions such as UE IP address allocation and PDU session control.

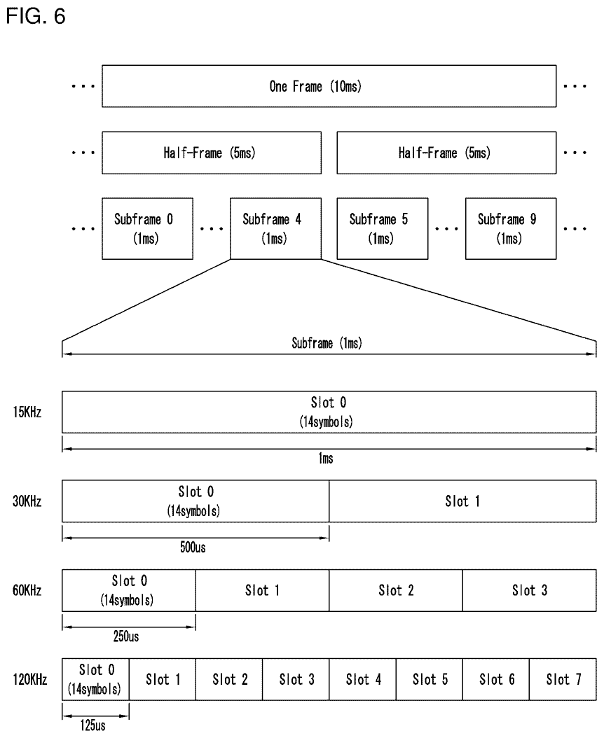

FIG. 6 is a diagram illustrating a frame structure applicable to NR.

Referring to FIG. 6, a frame may be 10 milliseconds (ms) long and include ten subframes each being 1 ms long.

In NR, uplink and downlink transport layers may each include frames. A radio frame may be 10 ms long and be defined as two 5 ms half-frames (HF). A half-frame may be defined as five 1 ms subframes (SF). A subframe is divided into one or more slots, and the number of slots in the subframe depends on subcarrier spacing. Each slot includes twelve or fourteen OFDM (A) symbols according to a cyclic prefix (CP). When a normal CP is used, each slot includes fourteen symbols. When an extended CP is used, each slot includes twelve symbols. Here, the symbols may include OFDM symbols (or CP-OFDM symbols) and SC-FDMA symbols (or DFT-s-OFDM symbols).

One or more slots may be included in a subframe according to the subcarrier spacing.

Table 1 below shows a subcarrier spacing configuration u.

TABLE 1

| μ | Δf = 2^{μ} · 15[kHz] | Cyclic prefix (CP) |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows the number of slots per frame

$${N}_{slot}^{frame , μ} ,$$

the number of slots per subframe

$${N}_{slot}^{subframe , μ} ,$$

the number of symbols per slot

$${N}_{symb}^{slot} ,$$

etc. according to the subcarrier spacing configuration μ.

TABLE 2

| ${N}_{symb}^{slot}$ | ${N}_{slot}^{frame , μ}$ | ${N}_{s l o f}^{subframe , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows the number of symbols per slot, the number of slots per frame, and the number of slots per subframe (SF) according to SCS when an extended CP is used.

TABLE 3

| SCS (15 · 2^{μ}) | ${N}_{symb}^{slot}$ | ${N}_{slot}^{frame , μ}$ | ${N}_{slot}^{subframe , μ}$ |
|---|---|---|---|
| 60 kHz (μ = 2) | 12 | 40 | 4 |

NR supports a number of numerologies (or subcarrier spacing (SCS)) to support various 5G services. For example, NR supports a wide area at conventional cellular bands when the SCS is 15 kHz, supports a dense-urban, a lower latency, and a wider carrier bandwidth when the SCS is 30 kHz/60 kHz, and supports a bandwidth higher than 24.25 GHz to fix phase noise when the SCS is 60 kHz or higher.

An NR frequency band may be defined as two types of frequency ranges FR1 and FR2. Numerical values of the frequency ranges may be changed, and for example, frequency ranges of the two types of frequency ranges FR1 and FR2 may be as shown in Table 4 below. For convenience of description, among frequency ranges used in an NR system, FR1 may be sub 6 GHz range, and FR2 may be above 6 GHz range and be referred to as a millimeter wave (mmW).

TABLE 4

| Frequency range | Corresponding | Subcarrier |
|---|---|---|
| designation | frequency range | spacing |
| FR1 | 450 MHz to 6000 MHz | 15, 30, 60 kHz |
| FR2 | 24250 MHz to 52600 MHz | 60, 120, 240 kHz |

As described above, the numerical values of the frequency ranges of the NR system may be changed. For example, FR1 may include a band of 410 MHz to 7125 MHz as shown in Table 5 below. That is, FR1 may include a frequency band of 6 GHz or higher (or 5850 MHz, 5900 MHz, 5925 MHz, or the like). For example, a frequency band of 6 GHz or higher (or 5850 MHz, 5900 MHz, 5925 MHz, or the like), which is included in FR1, may include an unlicensed band. The unlicensed band can be used for various purposes, e.g., communication for vehicles (e.g., autonomous driving).

TABLE 5

| Frequency range | Corresponding | Subcarrier |
|---|---|---|
| designation | frequency range | spacing |
| FR1 | 410 MHz to 7125 MHz | 15, 30, 60 kHz |
| FR2 | 24250 MHz to 52600 MHz | 60, 120, 240 kHz |

In the NR system, OFDM (A) numerology (e.g., SCS, CP length, etc.) may be set differently for multiple cells merged into one UE. Accordingly, (absolute time) periods of time resources consisting of the same number of symbols (e.g., SFs, slots, or TTIs) (referred to collectively as time units (TUs) for convenience of description) may be set differently for merged cells.

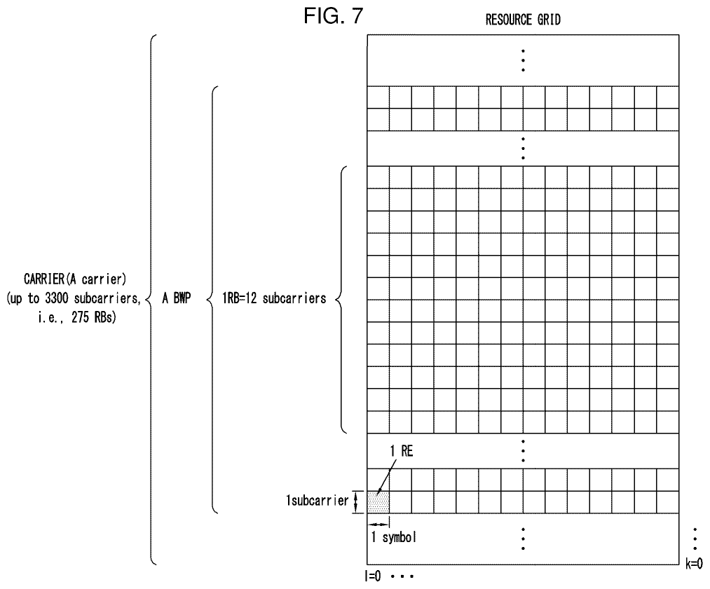

FIG. 7 is a diagram illustrating a slot structure of NR.

Referring to FIG. 7, a slot includes a plurality of symbols in a time domain. For example, one slot may include fourteen symbols in the case of a normal CP but may include twelve symbols in the case of an extended CP. Alternatively, one slot may include seven symbols in the case of the normal CP but may include six symbols in the case of the extended CP.

A carrier includes a plurality of subcarriers in a frequency domain. A resource block (RB) may be defined as a plurality of consecutive subcarriers (e.g., twelve consecutive subcarriers) in the frequency domain. A bandwidth part (BWP) may be defined as a plurality of consecutive (P) RBs in the frequency domain and may correspond to one numerology (e.g., a SCS, a CP length, or the like). A carrier wave may include up to N (e.g., five) BWPs. Data communication may be performed through an activated BWP. Each element may be referred to as a resource element (RE) in a resource grid, and one complex symbol may be mapped thereto.

A physical downlink control channel (PDCCH) may include one or more control channel elements (CCE) as shown in the following table.

TABLE 6

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through resources including one, two, four, eight or sixteen CCEs. Here, each CCE includes six resource element groups (REGs), and one REG includes one resource block in the frequency domain and one orthogonal frequency division multiplexing (OFDM) symbol in the time domain.

Meanwhile, in NR, a new unit called a control resource set (CORESET) may be employed. A UE may receive the PDCCH from the CORESET.

An integrated access and backhaul link (IAB) will be described below. Meanwhile, for convenience of description, a proposal method will be described below based on the new RAT (NR) system. However, a range of systems to which the proposed method is applicable may be extended to other types of systems such as 3GPP LTE/LTE-A systems, as well as the NR system.

One potential technology aimed at realizing future cellular network deployment scenarios and applications enables flexible and very dense deployment of NR cells without proportionally densifying transport networks to support wireless backhaul and relay links.

It is expected that with massive multi-input multi-output (MIMO) or natural deployment of a multi-beam system, a larger bandwidth (e.g., an mmWave spectrum) will be available in NR, compared to LTE, and thus opportunities for integrated access and backhaul links will be generated. Therefore, a number of control and data channels/procedures defined to provide connection or access to UEs can be built to allow easier deployment of a dense network of self-backhauled NR cells in a more integrated manner. Such a system is called an IAB.

The present disclosure defines the following:
AC(x): Access link between a node x and UEs; and
BH(xy): Backhaul link between a node x and a node y.

In this case, each node may be understood as a donor gNB (DgNB) or a relay node RN. Here, the DgNB or the donor node may be a gNB that provides a function of supporting a backhaul for IAB nodes.

In the present disclosure, when there are a relay node 1 and a relay node 2 and the relay node 1 is connected to the relay node 2 through a backhaul link to relay data transmitted to and received from the relay node 2, the relay node 1 will be referred to as a parent node of the relay node 2 and the relay node 2 will be referred to as a child node of the relay node 1 for convenience of description.

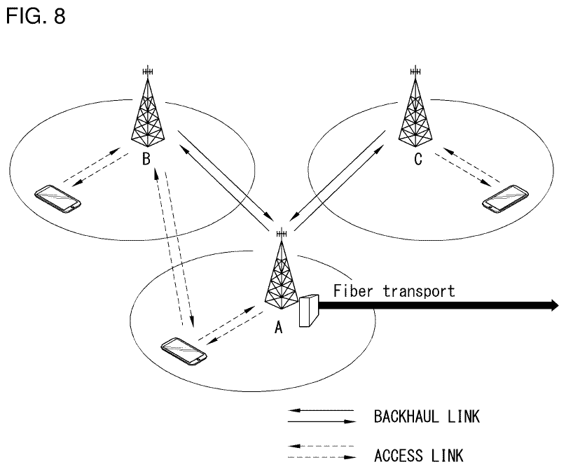

FIG. 8 is a diagram schematically illustrating an example of a network with integrated access and backhaul links (IAB).

Referring to FIG. 8, relay nodes (rTRP) may be capable of multiplexing access and backhaul links (i.e., beam-based operations) in a time, frequency or space domain. Different links may operate at the same frequency or different frequencies (each may be referred to as an “in-band” or “out-band” relay). Although efficient support of out-band relays is important in some NR deployment scenarios, it is very important to understand requirements of in-band operations involving close interworking with access links operating at the same frequency to accept duplex restrictions and avoid/relax interference.

Furthermore, when an NR system is operated in a millimeter wave spectrum, there are some unique problems, including experiencing severe short-term blocking that may not be easily mitigated by a current RRC-based handover mechanism due to a larger time scale required to complete a procedure compared to short blocking. Overcoming short blocking in millimeter wave systems may require a fast RAN-based mechanism for switching between rTRPs that do not necessarily require the inclusion of core networks. The aforementioned demand for easier deployment of self-backhauled NR cells and mitigation of short blocking for NR behavior in the millimeter wave spectrum raise a demand for the development of an integrated framework that allows fast switching of access and backhaul links. Over-the-air (OTA) coordination between rTRPs may also be considered as mitigating interference and supporting end-to-end path selection and optimization.

The following requirements and aspects should be addressed by the IAB for NR:
efficient and flexible behavior for in-band and out-band relay in indoor and outdoor scenarios;
multi-hop and redundant connectivity;
selection and optimization of end-to-end path
support for backhaul links with high spectral efficiency; and
support for legacy NR terminals.

A legacy NR is designed to support half-duplex devices. Accordingly, half duplex may be supported and worthy of being a target in an IAB scenario. Furthermore, IAB devices with full duplex may also be considered.

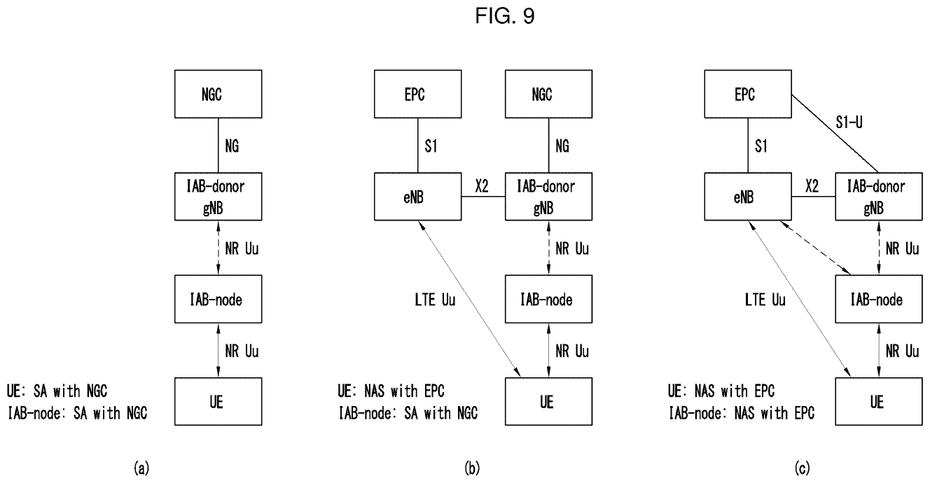

FIG. 9 is a diagram illustrating an example of an operation of an IAB system in a standalone (SA) mode and a non-standalone (NSA) mode.

Referring to FIG. 9, (a) illustrates examples of operations of a UE and an IAB node when NGC is considered in the SA mode, (b) illustrates examples of an operation of the IAB node when NGC is considered in the SA mode and an operation of the UE when EPC is considered in the NSA mode, and (c) illustrates examples of operations of the UE and the IAB node when EPC is considered in the NSA mode.

The IAB node may operate in the SA mode or the NSA mode. When operating in the NSA mode, the IAB node uses only an NR link for backhauling. The UE connected to the IAB node may select an operation mode different from that of the IAB node. The UE may further be connected to a core network of a different type from the IAB node connected thereto. In this case, (enhanced) dedicated core network ((e)DECOR) or slicing may be used for CN selection. The IAB node operating in the NSA mode may be connected to the same or different eNB(s). UEs operating in the NSA mode may be connected to an eNB that is the same as or different from IAB nodes to which the UEs are connected. FIG. 9 illustrates an example in which NGC is considered in the SA mode and an example in which EPC is considered in the NSA mode.

In the IAB scenario, when each relay node (RN) does not have a scheduling capability, a donor gNB (DgNB) should schedule all links between a DgNB, related relay nodes, and UEs. In other words, the DgNB should make scheduling decisions for all links by collecting traffic information from all related relay nodes and thereafter inform each relay node of scheduling information.

In contrast, dispersed scheduling may be performed when each relay node has a scheduling capability. Therefore, immediate scheduling can be performed in response to an uplink scheduling request from a UE, and backhaul/access links can be used more flexibly by reflecting a surrounding traffic situation.

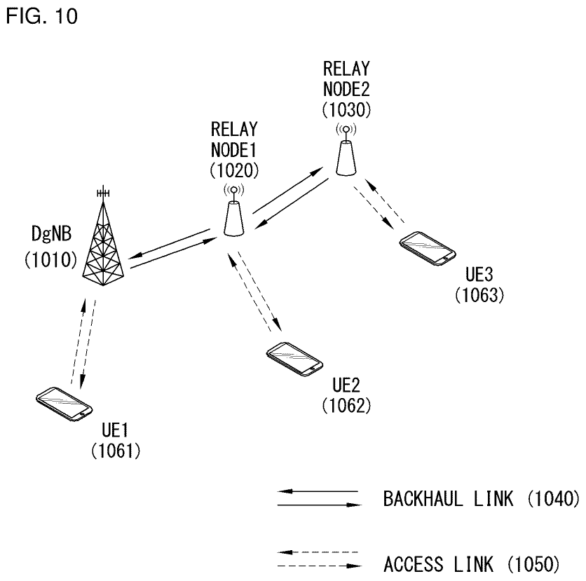

FIG. 10 is a diagram schematically illustrating an example of configurations of access and backhaul links in NR.

Specifically, FIG. 10 illustrates an example in which a backhaul link 1040 and an access link 1050 are configured when there are a DgNB 1010 and IAB relay nodes (RNs) 1020 and 1030. A backhaul link is connected between the DgNB 1010 and the relay node 1 1020 and a backhaul link is connected between the relay node 1 1020 and the relay node 2 1030.

Referring to FIG. 10, the DgNB 1020 may receive a scheduling request from a terminal 1 1061. In addition, the DgNB 1020 may receive a scheduling request from a terminal 2 1062 through the relay node 1 1020. In addition, the DgNB 1020 may receive a scheduling request from a terminal 3 1063 through the relay node 2 1030. Thereafter, the DgNB 1010 may schedule each of the terminals 1061, 1062, and 1063, and inform scheduling results to the terminals 1061, 1062, and 1063 through two backhaul links 1040 and three access links 1050, respectively. The scheduling centralized to one DgNB 1020 may cause scheduling delay and latency.

On the other hand, if each of the relay nodes 1020 and 1030 has scheduling capability, ‘distributed scheduling’ in which each of the relay nodes 1020 and 1030 performs scheduling may be performed. In this case, each of the relay nodes 1020 and 1030 can perform immediate scheduling after receiving a terminal's uplink scheduling request, and a surrounding traffic situation can be reflected during this scheduling, so that the backhaul links 1040 and/or access links 1050 can be used more flexibly.

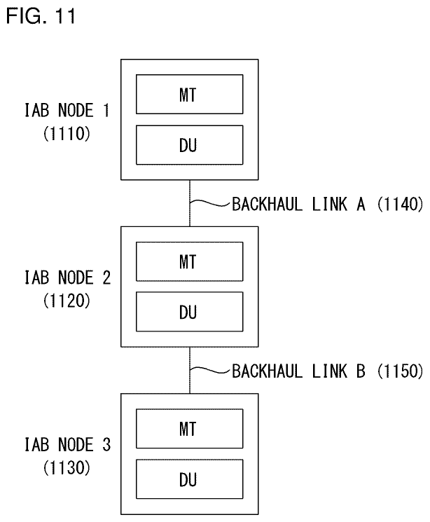

FIG. 11 is a diagram illustrating links and relationships between IAB nodes in NR.

Referring to FIG. 11, an IAB node 1 1110 is connected to an IAB node 2 1120 through a backhaul link A 1140. The IAB node 1 1110 is a parent node of the IAB node 2 1120 and the IAB node 2 1120 is a child node of the IAB node 1 1110 with respect to the backhaul link A. The IAB Node 2 1120 is connected to an IAB Node 3 1130 through a backhaul link B 1150. The IAB Node 2 1120 is a parent node of the IAB Node 3 1130 and the IAB Node 3 1130 is a child node of the IAB Node 2 1120 with respect to the backhaul link B.

Here, each of these IAB nodes 1110, 1120, and 1130 may perform two functions. One of the functions is mobile termination (MT) for maintaining a wireless backhaul connection to an upper IAB node or a donor node, and the other function is a distributed unit (DU) for providing access connections to UEs or connection to the MT of lower IAB nodes.

For example, in terms of the IAB node 2 1120, the DU of the IAB node 2 1120 functionally forms the backhaul link B 1150 with the MT of the IAB node 3 1130, and at the same time, the MT of the IAB node 2 1120 functionally forms the backhaul link A 1140 with the DU of the IAB node 1 1110. Here, a child link of the DU of the IAB node 2 1120 may be understood as the backhaul link B 1150 between the IAB node 2 1120 and the IAB node 3 1130. Here, a parent link of the MT of the IAB node 2 1120 may be understood as the backhaul link A 1140 between the IAB node 2 1120 and the IAB node 1 1110.

Coverage is a basic aspect of cellular network deployment. A mobile communication provider relies on different types of network nodes to provide batch coverage during cellular network deployment. A deployment of general full stack cells is an option but may not always be viable (e.g., there is no backhaul availability) or may not be economically viable.

A relay node may be used as one coverage improvement method. A relay node may receive a signal from a base station or a transmission and reception point (TRP) and transmit the signal to a UE or may receive a signal from the UE and transmit the signal to the base stations or the TRP. A signal received by the relay node may be amplified or beamformed and thereafter transmitted back to a counterpart node, and the coverage of the signal may be expanded. Relay nodes may be classified into various types of relay nodes according to functions thereof. Through an amplifier-and-forward (AF) relay, a received signal may be simply amplified and transmitted back. The AF relay may be referred to as a layer 1 (L1) relay, a repeater, or the like. Through a decode-and-forward (DF) relay, a received signal may be decoded to receive data, encoded again, and transmitted. The DF relay may include a layer 2 (L2) relay, a layer 3 (L3) relay, and the like. An integrated access and backhaul (IAB) node may be classified as the L3 relay according to a function thereof.

Among the types of relay nodes listed above, a repeater has a simple structure and operation and thus may be manufactured at a low cost and provide a high effect compared to invested costs. In general, in the case of a basic type of repeater, there is no need to distinguish between an uplink and a downlink, and a beamforming operation may not be performed. However, in order to maximize a coverage expansion effect, it may be desirable for a repeater to support the beamforming operation.

As a result, new types of network nodes have been considered to increase flexibility in building a network by mobile carriers. For example, an IAB has been introduced and new types of network nodes that do not need a wired backhaul have been developed. As another type of network node, there is a radio-frequency (RF) repeater that simply amplifies and delivers all received signals. The RF repeater has been deployed over a wide range of wireless communication systems to complement the coverage provided by a general full stack cell. In NR, RF and electromagnetic compatibility (EMC) requirements for RF repeaters for NR targeting both FR1 and FR2 have been specified.

RF repeaters offer cost-effective means for expanding network coverage but have limitations. RF repeaters simply perform amplify-and-forward (AF) operations without taking into account various factors that improve performance. These factors may include information about semi-static and/or dynamic downlink/uplink configuration, adaptive transceiver space beamforming, an ON-OFF state, and the like.

A network-controlled repeater (NCR) is an improvement of conventional RF repeaters with a function of receiving and processing side control information from a network. The side control information or auxiliary control information may allow the NCR to perform AF operations in a more efficient manner. Potential benefits of the NCR may include mitigation of unnecessary noise amplification, transmission and reception with better spatial orientation, and simplified network integration.

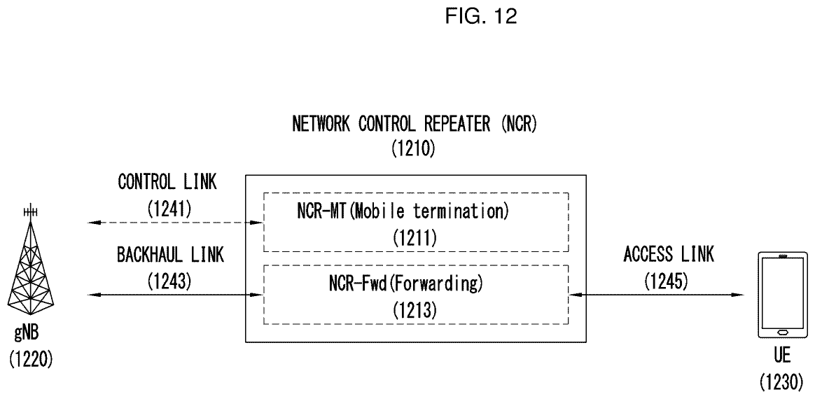

FIG. 12 is a diagram illustrating an example of a conceptual model of a network control repeater in NR.

Referring to FIG. 12, a network controlled repeater (NCR) may include an NCR-mobile terminal (MT) 1211 and an NCR-forwarding (Fwd) 1213. The NCR-MT 1211 may be defined as a performance entity that communicates with a gNB 1220 through a control link 1241 to exchange information, e.g., side control information for NCR-Fwd control. The control link 1241 may be based on an NRUu interface.

The NCR-Fwd 1213 may perform an AF operation of UL/DL RF signals between the gNB 1220 and a UE through a backhaul link 1243 and an access link 1245. An operation of the NCR-Fwd 1213 may be controlled according to side control information received from the gNB 1220.

As described above, an intelligent reflecting surface (IRS) has attracted attention as a relay node performing functions similar to those of a repeater. The IRS may also be referred to as a reconfigurable intelligent surface (RIS) or the like. The RIS is a planar surface with a number of passive elements formed of a metamaterial (hereinafter referred to as “RIS elements”), in which a phase of a received signal is changed by the RIS elements to form beams in a desired shape and reflect or pass a received signal to which the formed beam is applied. A phase shift of each RIS element may be independently controlled by a base station or TRP. In the present disclosure, the above-described beamforming operation may be referred to as reflection beamforming. The formed beam may be referred to as a reflection beam. Some RISs may pass a signal instead of reflecting the signal. In this case, the signal may pass through each RIS element of the RIS and undergo a phase change, thus forming a beam, and this process may be referred to as transmissive beamforming. The formed beam may be referred to as a transmissive beam. Hereinafter, reflection beamforming and transmissive beamforming will be referred to collectively as reflection beamforming, and a reflection beam and a transmissive beam will be referred to collectively as a reflection beam. Similar to a repeater, the RIS has a simple structure and operation to provide relay performance for performing beamforming and thus may be used for purposes similar to those of the repeater.

Various technical features for a new type of repeater or relay such as the NCR or RIS described above will be described below. A combination of the technical features described below may be applied within a range in which they are not contrary to each other. Hereinafter, “new type of repeater or relay” may be abbreviated as “repeater” for convenience of description.

The technical features described below will be described on the basis of an NR system but are applicable to existing wireless communication systems other than an NR system, such as next-generation wireless communication systems or LTE. For example, base stations may include a gNB and an eNB in relation to the technical features to be described below. In addition, the technical features described below may be applied not only to repeaters such as an NCR and an RIS but also to IAB nodes, a user equipment (UE), etc.

Various examples of a repeater suggested in the present disclosure will be described below.

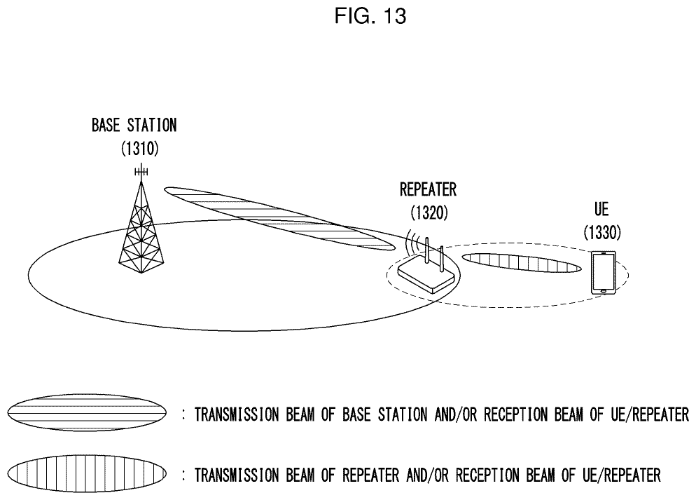

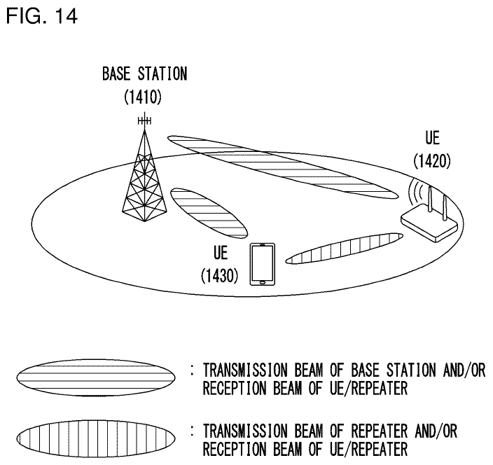

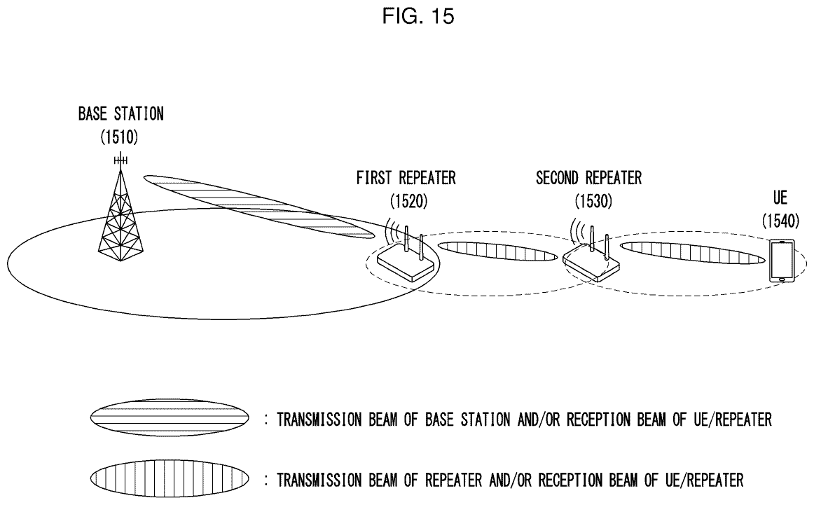

FIG. 13 illustrates an embodiment in which a repeater is located within cell coverage of a base station and a UE is located outside the cell coverage of the base station. FIG. 14 illustrates an embodiment in which a repeater and a UE are located within cell coverage of a base station. FIG. 15 illustrates an embodiment in which a first repeater is located within cell coverage of a base station, a second repeater is located outside the cell coverage, and a UE connected to the second repeater is located outside the cell coverage. In FIGS. 13 to 15, horizontal lines may represent a transmission beam of a base station and/or reception beams of a repeater and a UE, and vertical lines may represent a transmission beam of a repeater and/or a reception beam of a UE/repeater according to an embodiment of the present disclosure. The configurations of the present disclosure may be extended and applied to various environments other than the scenarios of FIGS. 13 to 15.

Hereinafter, a method and/or technical features proposed herein will be described with reference to the drawings. The method and/or the technical features proposed in the present disclosure are not limited by examples described below.

Various scenarios for a repeater proposed in the present disclosure will be described below. Here, the technical features proposed in the present disclosure may be extended and applied to environments/scenarios other than the various scenarios in the above example. The above example has been described with reference to the drawings of the present disclosure but technical features related thereto are not limited to the drawings that were referenced.

FIG. 13 is a diagram illustrating an example in which a repeater is located within cell coverage of a base station and a UE is located outside cell coverage of the base station according to an embodiment of the present disclosure.

Referring to FIG. 13, a pair of a transmission beam and a reception beam may be formed between a base station 1310 and a repeater 1320. The repeater 1320 may be a new type of repeater, a relay, a remote unit (RU), an open RAN-RU (ORAN-RU), or a UE according to the above-described embodiment of the present disclosure.

When the repeater 1320 is a UE, the repeater 1320 may include/perform the performance/operation of device-to-device (D2D) or a sidelink.

The repeater 1320 may receive data from the base station 1310 and transmit the received data to a UE 1330. In addition, the repeater 1320 may receive a control signal from the base station 1310 and transmit data to the UE 1330 on the basis of the control signal. That is, the repeater 1320 may relay data transmitted from the base station 1310 to the UE 1330 on the control signal received from the base station 1310. Here, a control operation indicated by the control signal may be performed according to a function of regions or a set of elements of a repeater to be described below.

FIG. 14 is a diagram illustrating an example in which a repeater and a UE are located within cell coverage of a base station according to an embodiment of the present disclosure.

Referring to FIG. 14, a UE 1430 may receive at least one of a transmission signal of a base station 1410 or a transmission signal of a repeater 1420. That is, the UE 1430 may receive both the transmission signal of the base station 1410 and the transmission signal of the repeater 1420. Alternatively, the UE 1430 may receive only the transmission signal of the base station 1410 or the transmission signal of the repeater 1420.

Meanwhile, the base station 1410 may configure a signal by separating information about the base station 1410 and information about the repeater 1420 from each other. When the UE 1430 receives both the information about the base station 1410 and the information about the repeater 1420, the UE 1430 may distinguish between the information about the base station 1410 and the information about the repeater 1420. When the UE 1430 receives the information about the base station 1410 or the information about the repeater 1420, the UE 1430 may identify (or fail to identify) whether the received information is the information about the base station 1410 or the information about the repeater 1420.

In this regard, the UE 1430 may distinguish between information received directly from the base station 1410 and information received through the repeater 1420. In this case, the UE 1430 may be in a radio resource control (RRC) connected state with respect to each of the base station 1410 and the repeater 1430. The UE 1430 may fail to distinguish between information directly received from the base station 1410 and information received through the repeater 1420. In this case, the UE 1430 may be in the RRC connected state with respect to the base station 1410 between the base station 1410 and the repeater 1420.

FIG. 15 illustrates an example in which a first repeater is located within cell coverage of a base station, a second repeater is located outside the cell coverage, and a UE connected to the second repeater is located outside the cell coverage according to an embodiment of the present disclosure.

FIG. 15 illustrates an example in which data is transmitted to a UE by configuring a repeater based on a multi-hop. Referring to FIG. 15, in an embodiment, the multi-hop may include a first repeater 1520 and a second repeater 1530. That is, a base station 1510 transmits data to the first repeater 1520 through a transmission beam of the base station 1510, and the first repeater 1520 transmits the data received from the base station 1510 to the second repeater 1530 through a reception beam of the first repeater 1520. The second repeater 1530 may transmit the data received through the reception beam of the second repeater 1530 to a UE 1540 through a transmission beam of the second repeater 1530.

Hereinafter, a structure of an antenna of a repeater will be described.

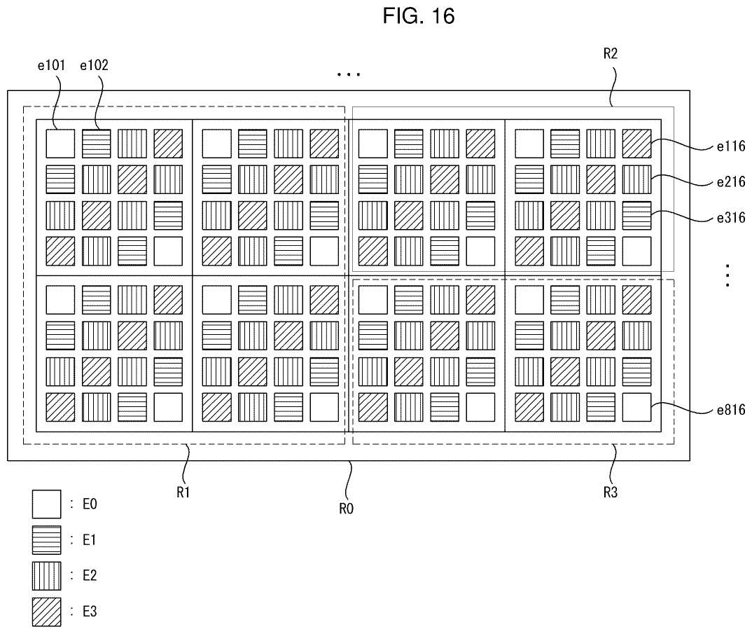

FIG. 16 is a diagram illustrating a structure or form of an antenna of a repeater according to an embodiment of the present disclosure.

An antenna of a repeater according to the embodiment of the present disclosure may include a “metamaterial-based antenna (metamaterial antenna)” and/or a “metasurface-based antenna (metasurface antenna).” The form of the antenna may be a panel-based form. Hereinafter, for convenience of description, “structure or form of an antenna” may be abbreviated as “antenna structure” or “antenna.”

For reference, the metamaterial antenna is an antenna that is an electrically small structure for realizing a negative dielectric constant and a negative permeability, which cannot be obtained from existing materials, to improve a radiation gain and a bandwidth, control a radiation direction, realize a reconfigurable antenna, and improve a beam scanning range of an array antenna. A metamaterial is an artificial material intentionally designed and implemented to draw reactions that are difficult or impossible to achieve with natural or complex materials, i.e., an artificial composite designed to have arbitrary electromagnetic characteristic values that cannot be obtained from metal structures of a certain wavelength or less in the natural world.

The metasurface is a two-dimensional (2D) extension of a metamaterial, and conceptually, an electronic structure whose horizontal and vertical lengths are much greater than a wavelength and whose thickness is much less than the wavelength, and in which distances between periodically arranged radiating elements are much less than the wavelength. First, a typical example of a metasurface antenna is the metasurface antenna proposed by Mosallaei and Sarabandi. The metasurface antenna is a metal patch periodically printed on a 2D space on a high dielectric material covered with a metal, and enables miniaturization and greatly improves a bandwidth and radiation properties. Second, a typical example of a metasurface antenna is the metasurface antenna proposed by Peresidis, etc. The metasurface antenna is a low-profile high-gain antenna with an artificial magnetic conductor (AMC) surface and includes a small patch radiation element surrounded by the AMC surface.

The antenna of the repeater may include multiple elements. Here, the antenna may correspond to one element of the repeater, multiple elements of the repeater, or regions/a set of the multiple elements.

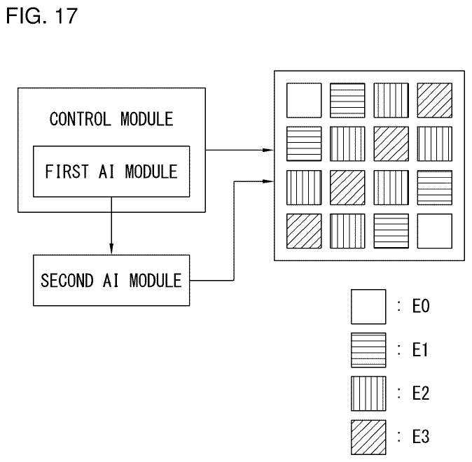

FIG. 17 is a diagram illustrating an example of a control module of a repeater according to an embodiment of the present disclosure.

For example, an operation of an element of an antenna of the repeater antenna may be controlled by the control module. A control signal for the control module of the repeater may be received from a base station or another repeater. For example, in FIGS. 13 to 15, the repeaters 1320, 1420, and 1520 may receive a control signal from the base stations 1310, 1410, and 1510, respectively, and the second repeater 1530 of FIG. 15 may receive a control signal from the first repeater 1520.

Elements E0, E1, E2, and E3 of an antenna of a repeater according to an embodiment of the present disclosure may be directly or indirectly connected to a pre-trained artificial intelligence (AI) module.

For example, as illustrated in FIG. 17, the control module may include a first AI module and be operated using the first AI module. As another example, as illustrated in FIG. 17, a second AI module connected to the control module may be operated through the control module. As another example, one or both of the first AI module and the second AI module in FIG. 17 may be omitted.

Here, the AI modules may transmit and receive wired and wireless signals (e.g., sensor information, a user input, a training model, a control signal, etc.) to and from external devices such as other AI devices or AI servers. The AI modules may determine at least one executable operation thereof on the basis of information determined or generated by a data analysis algorithm or a machine learning algorithm. The AI modules may control the elements of the antenna to perform the at least one executable operation. In addition, the AI modules may train a model consisting of artificial neural networks using training data, and perform AI processing with an AI server.

### [Embodiments for Configuration of Regions of Repeater Elements]

Regions of elements of a repeater and/or regions of elements of an antenna of the repeater proposed in the present disclosure will be described below. For convenience of description, “elements of the repeater” and/or “elements of the antenna of the repeater” may be abbreviated as “repeater elements” or “repeater antenna elements.” The “regions” of the repeater elements may be interpreted as a “set” or “group” of the elements of the repeater. In addition, in the present disclosure, the regions of the repeater antenna elements may be expressed as “regions,” “a set”, or “a group.”

### <First Embodiment for Configuration of Regions of Repeater Elements>

Regions of repeater elements may be physically or spatially divided into at least one region. Specifically, the repeater elements may be configured as one region or a plurality of regions. In FIG. 16, a region R0 is an example of an entire region configured by all repeater elements. In FIG. 16, regions R1, R2, and R3 are divided from the entire region R0. In this case, each of the regions R1, R2, and R3 may include different elements E0, E1, E2 and E3.

### <Second Embodiment for Configuration of Regions of Repeater Elements>

Regions of repeater elements 1600 may be divided in units of elements. That is, one region may be configured to include one element. For example, elements E0 to E3 of the repeater elements 1600 may be configured to be included in different regions. That is, the elements E0 may be included in a region E0, the elements E1 may be included in a region E1, the elements E2 may be included in a region E2, and the elements E3 may be included in a region E3. The second embodiment is illustrated in FIG. 17. That is, FIG. 17 illustrates that sixteen regions include the same elements.

### <Third Embodiment for Configuration of Regions of Repeater Elements>

One element may be included in two or more different regions in a specific space. Specifically, one element may be included in two or more regions when regions of repeater elements are physically or spatially divided as in the first embodiment of FIG. 16 or the regions of the repeater elements are divided and defined in units of elements as in the second embodiment of FIG. 17. For example, in FIG. 16, an element e101 may be included in the region R1 of FIG. 16 that is physically or spatially divided, and at the same time, may be included in the region E0 of FIG. 17 that is divided in units of elements.

### <Fourth Embodiment for Configuration of Regions of Repeater Elements>

Among the regions defined in the first to third embodiments described above, regions may belong to each other or there may be an intersection between defined regions.

For example, regions of repeater elements defined according to the first, second, and third embodiments may belong to each other or there may be an intersection between the regions.

For example, a region defined in the second or third embodiment may be included in a region defined in the first embodiment. Specifically, regions divided in units of elements according to the second embodiment or two or more regions divided from a region of one element according to the third embodiment may be included in regions of the elements of the repeater that are spatially or physically divided according to the first embodiment.

For example, a region defined in the first or third embodiment may be included in a region defined in the second embodiment. Specifically, regions divided spatially or physically according to the first embodiment or two or more regions divided from a region of one element according to the third embodiment may be included in regions of the elements of the repeater divided in units of elements according to the second embodiment.

For example, a region defined in the first or second embodiment may be included in a region defined in the third embodiment. Specifically, regions divided spatially or physically according to the first embodiment or regions divided in units of elements according to the second embodiment may be included in two or more regions divided from a region of one element according to the third embodiment.

In addition, there may be an intersection between regions defined in the first, second, and third embodiments.

### [Function of Regions of Repeater Elements]

A function of regions of repeater elements proposed in the present disclosure will be described below.

The function of the regions of the repeater elements may be defined/divided as described below.

For example, the regions of the repeater elements may be configured based on at least one of a multi-panel, a multi-TRP, an antenna group connected to each RF, an active element, a passive element, cross polarization, circular polarization, beamforming, or phase shift.

The active element may be either an element with a signal amplification function or an element with the signal amplification function and a signal phase shift function. The passive element may be either an element with the signal phase shift function or an element that does not have the signal phase shift function but has a function of reflecting, refracting, absorbing or transmitting a received signal. A way of distinguishing between the active element and the passive element may be further subdivided according to a function and/or performance of an element. For example, an element with only the signal amplification function may be defined as a first type element, and an element with the signal amplification function and the signal phase shift function may be defined as a second type element. Similarly, an element with only the signal phase shift function may be defined as a third type element, and an element that does not have the signal phase shift function but has a function of reflecting, refracting, absorbing, and transmitting a received signal may be defined as a fourth type element.

As another example, the regions of the repeater elements may be configured based on at least one of reflection, refraction, absorption, or transmission of a received signal.

As another example, the regions of the repeater elements may be configured based on a function directly or indirectly associated with an AI module.

Meanwhile, the functions of the elements according to the above-described examples may exist together. That is, one element may have a plurality of functions.

In addition, the regions of the repeater elements may be configured to be spatially or physically divided on the basis of a function of the regions, configured to be divided in units of elements, or configured to divide one element into two or more regions, or regions of elements of a repeater antenna may be configured to belong to each other or achieve an intersection between the regions.

For example, a multi-panel or multi-TRP may be configured such that elements related thereto and/or regions of the elements may be divided spatially or physically.

As another example, an antenna group connected to each RF may be configured to be divided spatially or physically or divided in units of elements.

As another example, the active element and the passive element may be configured to be divided spatially or physically or divided in units of elements.

As another example, an element for a function of reflecting, refracting, absorbing, or transmitting a received signal may be configured to be divided spatially or physically or divided in units of elements.

As another example, in the case of cross polarization, one element may be configured to be divided into two or more regions for +45 degree polarization and −45 degree polarization. For example, each of the elements of the repeater may be defined as including a +45 degree polarization element and a −45 degree polarization element. In this case, the +45 degree polarization element of each of the elements may be defined as a first region, and the −45 degree polarization element of each of the elements may be defined as a second region.

As another example, circular polarization may be configured to be spatially or physically divided into right-hand polarization (RHP) and left-hand polarization (LHP).

In relation to the regions of the elements of the repeater antenna, the regions of the repeater elements may be configured on the basis of performance determined by the repeater or performance indicated by control information transmitted from a base station.

For example, in an embodiment based on performance determined by a repeater, the repeater may configure regions of repeater elements on the basis of the performance determined by the repeater, and report the determined performance to the base station.

For example, in an embodiment based on control information transmitted from a base station, a repeater may report performance applicable thereto to the base station. The base station receiving the report may transmit control information (or response information) to the repeater in response to the report received from the repeater. The control information (or response information) may include information indicating performance to be configured in the repeater. The repeater receiving the control information (or response information) may configure regions of the repeater elements on the basis of the control information. Signaling of control information transmitted from a base station to a repeater will be described below.

Control signaling proposed in the present disclosure may include some or all of RRC signaling, a medium access control-control element (MAC-CE), and downlink control information (DCI).

In an embodiment of the present disclosure related to control signaling, a base station may transmit, to a repeater, control information for control of an antenna of the repeater according to a function of regions of repeater elements, based on, for example, energy saving, interference mitigation, security, wireless charging, a location of a UE, and the like.

The control information may be transmitted periodically, quasi-periodically or aperiodically.

The repeater may report, to the base station, a function (capability) thereof among functions of the regions of the repeater elements. In addition, the repeater may inform a UE of functions thereof through the configuration of a transmission signal of the base station. Here, a procedure of transmitting or receiving UE capability information by an NR system may be borrowed in a procedure of transmitting or receiving report information about the function of the repeater. A concrete example of the procedure of transmitting or receiving the UE capability information will be described below.

For example, the number of beams or the number of panels may be reported to the base station.

As another example, the role (or function) of AI, an AI model, or an AI input/output value may be reported to the base station in relation to a function directly or indirectly associated with an AI module. For example, the repeater may report information such as sensor information, a user input, a training model, a control signal, and the like to the base station.

As another example, an applicable frequency band and a maximum level of power to be transmitted may be reported to the base station, in addition to the function of the region of the elements of the repeater.

Meanwhile, examples of the report may also be applied to a UE. That is, the repeater may transmit information reported (or transmitted) to the base station to the UE.

When a configuration of the region of the repeater elements is stored (embedded) in a memory of the repeater, the repeater may transmit information about the configuration of the region to the base station. In addition, the repeater may inform the UE of the functions thereof through the configuration of a transmission signal of the base station.

When the region of the repeater elements is not stored (embedded) in the repeater, the repeater may configure a region (or set) of the elements according to an instruction from the base station.

Meanwhile, some or all of the control signaling may be configured as cell-specific, beam-specific, group-specific, or UE-specific. For example, some of cell-specific, beam-specific, or group-specific parameters may be updated through UE-specific parameters. Here, the term “UE-specific” may be understood to mean “repeater-specific.”

Meanwhile, after receiving the control information, the repeater may perform a corresponding function, that is, an operation/function indicated by the control information.

An operation performed by the repeater may be, for example, a power-on/off operation. As another example, the operation performed by the repeater may represent +45 degree polarization, −45 degree polarization, RHP, or LHP.

Here, the power-off operation may be an operation performed when power consumption is zero or a situation or operation in which only a minimum amount of power (power for monitoring or receiving control information or power for performing an arbitrary operation) is maintained.

Alternatively, the power-off operation may represent a case in which one or more elements (e.g., a pin diode) of a control module connected to one or more elements is powered off.

Meanwhile, operations related to power may be divided into an on-operation and an off-operation as described above or divided into multiple modes. For example, an operation of the repeater when power consumption of the repeater is zero or when power consumption is zero may be defined as a first mode, and an operation of the repeater that performs only an operation for monitoring control signaling may be defined as a second mode. In addition, an operation of powering off one or more elements of the control module connected to one or more elements may be defined as a third mode. Here, the repeater may perform an operation in one of the first mode, the second mode, and the third mode according to an instruction from the base station.

Meanwhile, the base station may transmit part or all of control signaling to a UE directly or through the repeater or may not transmit the control signaling.

Here, when the UE transmits control information to the repeater or the base station, both the base station and the repeater may receive the control information.

In relation to the control signaling, a signaling procedure between the base station and the repeater may borrow a signaling procedure between the base station and the UE. Signals transmitted from and received by the repeater may be transmitted and received through a physical layer channel (e.g., a PUSCH, a PUCCH, a PDSCH, or a PDCCH) of the NR system. For example, control information may be transmitted from the base station to the repeater through the PDCCH, and information reported by the repeater to the base station may be transmitted through the PUSCH.

A configuration of control signaling (or control information) proposed in the present disclosure will be described below.

For example, signaling for control of each element of an antenna of the repeater may be configured.

For example, when the number of elements is 128, a signal or field for control of the antenna or form may be 7 or 8 bits long.

Alternatively, for a polarization operation of the repeater, the signal or field may have a length/bits corresponding to 2× (the number of elements).

For example, when the length of the signal or field corresponds to 7 bits, the length may be understood explicitly as 7 bits or be based on implicit interpretation (e.g., a frame number or the like). Here, the signal or field may be interpreted on the basis of a combination of a first field defined explicitly for control of the antenna or form and part of or an entire second field defined explicitly for other purposes, such as a frame number, a cell identifier, or the like.

For example, the control information may be transmitted in units of element identifiers (IDs) or together with the element IDs. Alternatively, a mapping relationship between a configuration order of the control information and the element IDs may be implicitly known to a receiving side of the control information.

For example, the regions of the repeater elements may be configured to be divided spatially or physically, configured to be divided in units of elements, or configured to divide one element into two or more regions, the regions of the elements of the repeater antenna may belong to each other, or signaling may be configured to control the regions configured to achieve an intersection therebetween.

Here, for example, when two regions are configured, control signaling for the regions may be 1 or 2 bits long similar to signaling for control of the elements of antenna of the repeater.

For example, signaling for control of the antenna of the repeater may be configured as hierarchical signaling.

Here, the regions or set of the repeater elements may be configured to be divided spatially or physically, configured to be divided in units of elements, or configured to divide one element into two or more regions, the regions of the elements of the repeater antenna may belong to each other, or signaling may be configured to control sub-regions or sub-elements in the regions configured to achieve an intersection therebetween.

Here, the regions of the elements of the repeater antenna may belong to each area or there may be an intersection between the regions, and when another region is included in one region, control signaling for the other region may be configured.

Alternatively, signaling for control of the elements in the regions may be configured.

When control signaling for control of the antenna or form is configured as hierarchical signaling, a control signaling transmission interval of a higher layer (i.e., an upper region) may be greater than that of a lower layer when control signaling is transmitted to the repeater to control the antenna of the repeater according to the functions of the regions or set of the repeater elements, for example, according to energy saving, interference mitigation, security, wireless charging, the location of the UE, and the like.

For example, higher layer signaling may be transmitted through RRC signaling or medium access control-control element (MAC-CE), and lower layer signaling may be transmitted through downlink control information (DCI).

As another example, the base station may transmit part or all of control signaling to the UE directly or through the repeater or may not transmit the control signaling. Here, part of the control signaling may be configured as upper layer signaling.

For example, when operation signaling for elements or regions (similar to a codebook) is stored (embedded) in a memory or the like, the base station may transmit an index for a corresponding operation to the repeater.

Here, the repeater may report a configuration of the operation signaling stored (embedded) in the memory to the base station. In addition, the repeater may inform the UE of the configuration of the operation signaling thereof through the configuration of a transmission signal of the base station.

In relation to the configuration of the control signaling described above, power control parameters or frequency band parameters may be transmitted together with the control signaling. In addition, parameters for operation of an AI module (a parameter indicating whether to operate the AI module, a function value of the AI module, an input/output value for training the AI module, etc.) may also be transmitted. To this end, the function (capability) of the repeater may be reported to the base station or the UE.

In relation to the configuration of the control signaling described above, the element IDs or region IDs may be transmitted with the control signaling or in units of the element IDs or region IDs. Alternatively, a mapping relationship between the configuration order of signaling and the element IDs or the region IDs may be implicitly known to a receiving side. In this case, the receiving side may interpret control signaling on the basis of the mapping relationship.

In relation to the configuration of the control signaling described above, a transmission interval may vary for each parameter of the signaling. Some parameters may be transmitted through RRC signaling or a MAC-CE, and other parameters may be transmitted through DCI.

In relation to the configuration of the control signaling described above, some parameters may be configured by RRC signaling, and activated or deactivated by the MAC-CE or DCI.

In relation to the configuration of the control signaling described above, some parameters may be configured by RRC signaling, and an RRC index thereof may be indicated by the MAC-CE or DCI.

In relation to the configuration of the control signaling described above, an example in which the repeater includes two panels and each of the two panels includes multiple elements may be considered. When hierarchical control signaling is applied to the above example, higher layer signaling may be understood as signaling for control of panel-levels/units and lower layer signaling may be understood as signaling for control of element-levels/units. Here, for example, RRC signaling may be used for control of the panel-levels/units, and the MAC-CE or DCI may be used for control of the element-levels/units. Alternatively, RRC signaling or the MAC-CE may be used for control of the panel-levels/units, and the DCI may be used for control of the element-levels/units.

In the above example, the repeater may transmit some or all of the higher layer signaling and the lower layer signaling to the UE. For example, the repeater may transmit only information for control of the panel-levels/units to the UE and may not transmit information for control of the element-levels/units.

In relation to the configuration of the control signaling described above, a DCI format proposed herein may be defined for repeaters such as an NCR and an RIS. The DCI format proposed herein may include previously defined DCI formats (e.g., DCI format 0_0 and/or DCI format 0_1 for uplink scheduling, DCI format 1_0 and/or DCI format 1_1 for downlink scheduling, and the like). When the previously defined DCI formats are used for control signaling of the repeater, a field indicating control information for the repeater may be defined in the previously defined DCI formats.

Various embodiments in which an antenna of a repeater is configured based on some or all of the configurations proposed herein and the repeater is controlled according to control information related to the repeater will be described below.

### First Embodiment

In a first embodiment, it is assumed that an antenna of a repeater may include two panels or TRPs. Here, each of the panels or TRPs may include 64 elements.

A region of a panel 1 and a region of a panel 2 may be configured by a function of configuring regions or a set of elements of the repeater.

For signaling for control of the region of the panel 1 and the region of the panel 2, a signal or field related to the signaling may be 2 bits long.

For the performance of a function/operation based on control signaling, the repeater may turn on/off the region of the panel 1 or the region of the panel 2. That is, the control signaling may indicate an on-operation and/or an off-operation for the region of the panel 1 and/or the region of the panel 2.

When the control signaling is provided to a UE, the UE may identify whether the region of the panel 1 or the region of the panel 2 of the repeater is on/off or whether the on-operation or the off-operation has been performed.

### Second Embodiment

In a second embodiment, it is assumed that elements of an antenna of a repeater have a polarization function. In this case, regions (a +45-degree region and a −45-degree region) may be configured for cross-polarization among functions of regions/set/group of elements of the repeater.

For signaling for control of the +45-degree region and the −45-degree region, a signal or field related to the signaling may be 1 bit long.

For the performance of a function based on control signaling, the repeater may configure an antenna thereof or the elements or regions at +45 degrees or −45 degrees.

When the control signaling is provided to the UE, the UE may also identify the polarization configuration of the repeater.

### Third Embodiment

Technical features to be described below in relation to the first embodiment may be applied to a third embodiment.

For example, signaling for control of an antenna of a repeater may be configured as hierarchical signaling, and a higher layer (region) of the hierarchical signaling may include a panel 1 and a panel 2. A lower layer (lower region) of the hierarchical signaling may be configured as a cross-polarization region for each panel. A sub-lower layer (region) of the hierarchical signaling may include polarization-specific elements and polarization-specific elements. In addition, a procedure similar to that in the first embodiment may be performed up to the lower layer or the sub-lower layer.

### Fourth Embodiment

Technical features to be described below in relation to the first embodiment may be applied to a fourth embodiment.

For example, signaling for control of an antenna of a repeater may be configured as hierarchical signaling, and a higher layer (region) of the hierarchical signaling may be configured as one region (entire region).

Part or all of control signaling may be configured as cell-specific, beam-specific, group-specific, or UE-specific, and control signaling indicating a higher layer (region) may be configured with a cell-specific parameter (1 bit).

After receiving control signaling, the repeater may perform a corresponding function, i.e., an operation/function indicated by the control signaling, and control signaling indicating a higher layer (region) may instruct to perform the power-off operation of the repeater in a cell when the cell-specific parameter is zero.

After receiving the control signaling, the repeater may perform the corresponding function, i.e., the operation/function indicated by the control signaling, and the control signaling indicating the higher layer (region) may instruct to apply RHP as polarization of the repeater in the cell when the cell-specific parameter is zero.

After receiving the control signaling, the repeater may perform the corresponding function, i.e., the operation/function indicated by the control signaling, and the control signaling indicating the higher layer (region) may instruct to perform the power-on operation only for an active element among elements of an antenna or form of the repeater in a cell when the cell-specific parameter is zero.

Meanwhile, the power-on operation and/or the power-off operation may be configured similar to discontinuous reception (DRX). For example, the power-on operation and/or the power-off operation of the present disclosure may be understood as DRX.

DRX is an operation mode in which a UE reduces battery power consumption to allow the UE to receive downlink channels discontinuously. That is, a UE configured to perform DRX may receive DL signals discontinuously to reduce power consumption.

A DRX operation is performed in a DRW cycle representing a time interval at which an on-duration is periodically repeated. The DRX cycle includes the on-duration and a sleep duration (or a DRX opportunity). The on-duration is a time interval at which a UE performs PDCCH monitoring to receive a PDCCH.

DRX may be performed in a radio resource control (RRC)_IDLE state (or mode), an RRC_INACTIVE state (or mode), or an RRC_CONNECTED state (or mode). In the RRC_IDLE state and the RRC_INACTIVE state, DRX may be used to discontinuously receive a paging signal.
RRC_IDLE state: a state in which a radio connection (RRC connection) is not established between a base station and a UE
RRC_INACTIVE state: a state in which a radio connection (RRC connection) has been established between the base station and the UE but is deactivated
RRC_CONNECTED State: a state in which a radio connection (RRC connection) has been established between the base station and the UE

Generally, DRX may be divided into idle mode DRX, connected DRX, and extended DRX.

DRX applied in the IDLE state may be referred to as the idle mode DRX, and DRX applied in a CONNECTED state may be referred to as connected mode DRX (C-DRX).

Extended/enhanced DRX (eDRX) is a mechanism for extending cycles of the idle mode DRX and the C-DRX, and may be generally used to apply (massive) IoT. In the idle mode DRX, whether to allow eDRX may be set on the basis of system information (e.g., SIB1). SIB1 may include an eDRX-allowed parameter. The eDRX-allowed parameter is a parameter indicating whether the idle mode extended DRX is allowed.

The idle mode DRX will be described below. In an idle mode, a UE may use DRX to reduce power consumption. A paging occlusion (PO) is a subframe that may be transmitted by a paging-radio network temporary identifier (P-RNTI) through a physical downlink control channel (PDCCH) (for addressing a paging message for NB-IoT), an MTC PDCCH (MPDCCH) or a narrowband PDCCH (NPDCCH).

In the P-RNTI transmitted through the MPDCCH, a PO may indicate a start subframe of repetition of the MPDCCH. In the case of the P-RNTI transmitted through the NPDCCH, the PO may indicate a start subframe of repetition of the NPDCCH when a subframe determined by the PO is not a valid NB-IoT downlink subframe. Therefore, a first valid NB-IoT downlink subframe after the PO is the start subframe of repetition of the NPDCCH.

One paging frame (PF) is a radio frame that may include one or more POs. When DRX is used, a UE may monitor only one PO per DRX cycle. One paging narrow band (PNB) is a narrow band at which the UE may receive a paging message. The PF, the PO, and the PNB may be determined based on DRX parameters provided in system information.

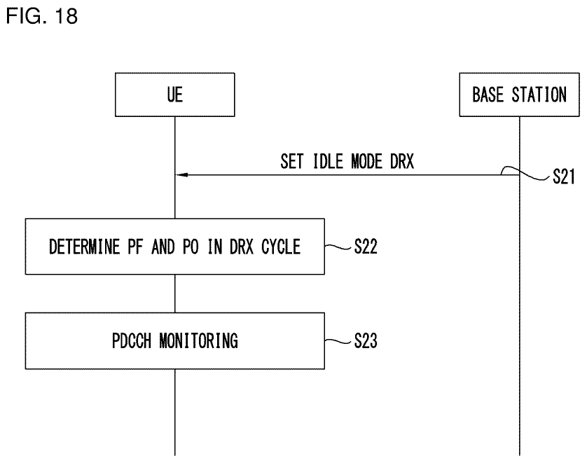

FIG. 18 is a diagram illustrating an example in which the idle mode DRX operation is performed in relation to the power-on operation and/or the power-off operation of the present disclosure.

Referring to FIG. 18, a UE may receive idle mode DRX configuration information from a base station through higher layer signaling (e.g., system information) (S21).

The UE may determine a paging frame (PF) and a paging occasion (PO) to monitor a PDCCH in a paging DRX cycle on the basis of the idle mode DRX configuration information (S22). In this case, the DRW cycle may include an on-duration and a sleep duration (or DRW opportunity).

The UE may monitor a PDCCH in the PO of the determined PF (S23). Here, the UE may monitor, for example, only one sub-frame (PO) per paging DRW cycle. Upon receiving a PDCCH scrambled using P-RNTI in the on-duration (i.e., when paging is detected), the UE may enter a connected mode and transmit or receive data to or from a base station.

The connected mode DRX (C-DRX) will be described below. The C-DRX is DRX applied in the RRC connected state. A DRX cycle of the C-DRX may include a short DRX cycle and/or a long DRX cycle. Here, the short DRX cycle may be optional.

When the C-DRX is set, a UE may perform PDCCH monitoring in an on-duration. If the PDCCH is successfully detected during the PDCCH monitoring, the UE may operate (or execute) an inactive timer and maintain an awake state. On the other hand, when the PDCCH is not successfully detected during the PDCCH monitoring, the UE may enter the sleep state after the on-duration ends.

When C-DRX is set, PDCCH reception opportunities (e.g., slots with a PDCCH search space) may be set discontinuously on the basis of a C-DRX configuration. In contrast, when C-DRX is not set, PDCCH reception opportunities (e.g., slots with a PDCCH search space) may be continuously set in the present disclosure.

Meanwhile, PDCCH monitoring may be limited to a time interval set to a measurement gap regardless of the C-DRX configuration.

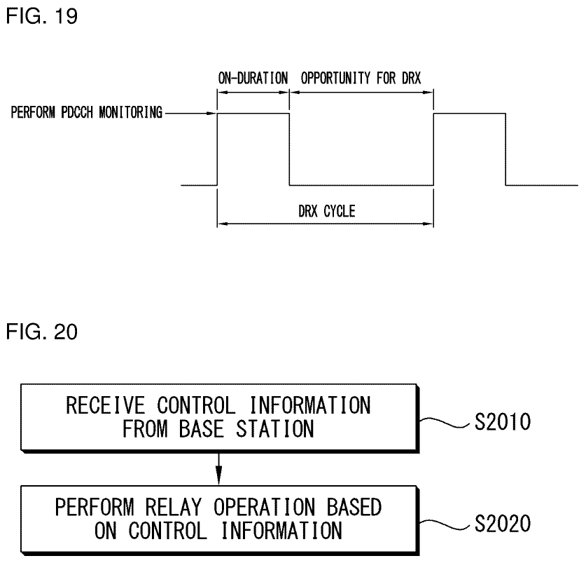

FIG. 19 is a diagram illustrating a DRX cycle in relation to a power-on operation and/or a power-off operation of the present disclosure.

Referring to FIG. 19, the DRX cycle includes an “on-duration” and an “opportunity for DRX.” The DRX cycle is defined as a time interval at which the “on-duration” is repeated periodically. The “on-duration” is a time period during which a UE performs PDCCH monitoring to receive a PDCCH. When DRX is set, the UE performs PDCCH monitoring in the “on-duration.” When a PDCCH is successfully detected during the PDCCH monitoring, the UE operates an inactivity timer and maintains the awake state. On the other hand, when a PDCCH is not successfully detected during the PDCCH monitoring, the UE enters the sleep state after the “on-duration” ends. Therefore, when DRX is set, the monitoring/reception of a PDCCH may be discontinuously performed in a time domain when the above-described/proposed procedure and/or method is performed. For example, in the present disclosure, when DRX is set, a PDCCH reception occasion (e.g., a slot with a PDCCH search space) may be discontinuously set according to the DRX configuration. On the other hand, when DRX is not set, the monitoring/reception of a PDCCH may be continuously performed in the time domain when the above-described/proposed procedure and/or method is performed. For example, in the present disclosure, when DRX is not set, a PDCCH reception occasion (e.g., a slot with a PDCCH search space) may be continuously set. Meanwhile, regardless of whether DRX is set or not, PDCCH monitoring may be limited in a time period set as a measurement gap.

Table 7 shows a process of a UE related to DRX (RRC_CONNECTED state). Referring to Table 7, DRX configuration information is received through higher layer (e.g., RRC) signaling, and whether DRX is to be on or off is controlled by a DRX command of a MAC layer. When DRX is set, PDCCH monitoring may be discontinuously performed when the procedure and/or the method described/proposed in the present disclosure is performed.

TABLE 7

| | Type of signals | UE procedure |
|---|---|---|
| Operation 1 | RRC signaling (MAC- | Receive DRX configuration |
| | CellGroupConfig) | information |
| Operation 2 | MAC CE ((Long)) DRX | Receive DRX command |
| | command MAC CE) | |
| Operation 3 | — | Monitor PDCCH in on- |
| | | duration of DRX cycle |

The MAC-CellGroupConfig may include configuration information necessary to set a media access control (MAC) parameter for a cell group. The MAC-CellGroupConfig may also include configuration information related to DRX. For example, the MAC-CellGroupConfig may include information for defining DRX as follows:
Value of drx-OnDurationTimer: defines the length of a start period of a DRX cycle;
Value of drx-InactivityTimer: defines the length of a time period during which a UE remains awake after a PDCCH occasion in which a PDCCH indicating initial UL or DL data is detected;
Value of drx-HARQ-RTT-TimerDL: defines the length of a maximum time period until a DL retransmission is received after an initial DL transmission is received;
Value of drx-HARQ-RTT-TimerDL: defines the length of a maximum time period until a grant for a UL retransmission is received after a grant for an initial UL transmission is received;
drx-LongCycleStartOffset: defines the length and start point of a DRX cycle; and
drx-ShortCycle (optional): defines the length of a short DRX cycle.

Here, during the operation of at least one of drx-OnDurationTimer, drx-InactivityTimer, drx-HARQ-RTT-TimerDL, or drx-HARQ-RTT-TimerDL, the UE remains awake and performs PDCCH monitoring at every PDCCH occasion.

Various embodiments based on some of the above-described technical features will be described below. Technical features that are proposed in the present disclosure but are not applied to the above-described embodiments may be additionally applied to the embodiments to be described below.

FIG. 20 is a diagram illustrating an example of an operating method of a repeater according to some embodiments of the present disclosure. Here, the repeater may be a repeater as described above, such as an NCR or an RIS, or a communication device capable of performing the functions of the repeater, such as a base station, a UE, or an IAB node.

The repeater may receive control information from a base station (S2010). Here, the repeater may include a plurality of elements. Here, the elements may include at least one of an antenna, a metasurface-based form, a metamaterial-based form, and a panel-based form. The control information may be configured based on the configuration of control signaling described above.

As described above, regions/set/group of the elements of the repeater may be configured on the basis of a function determined by the repeater or a function indicated by control information transmitted from a base station. In this case, the repeater may report functions applicable thereto to the base station, and configure the regions/set on the basis of a function indicated by control information or response information transmitted in response to the report from the base station in operation S2010. Alternatively, the repeater may configure the regions/set on the basis of a function determined by itself, and report the determined function to the base station. In this case, the control information transmitted from the base station in operation S2010 may include information indicating an operation of the regions/set.

Alternatively, the control information may be information for control of an antenna of the repeater according to functions of dividing/configuring the regions/set/group of the elements of the repeater. For example, in relation to the configuration of the regions of the elements of the repeater described above, the control information may indicate a function to be used for the repeater to configure the regions/set/group of the elements.

The repeater may perform a relay operation on the basis of the control information (S2020). The relay operation may include not only a signal relay operation but also at least one of operations related to various technical features proposed herein, e.g., an operation for control of the antenna of the repeater, a beamforming operation, an operation of giving a report to a base station, an operation of transmitting control information to a UE, an operation of dividing/configuring the regions/set/group of the elements of the repeater, and the power on/off operation described above.

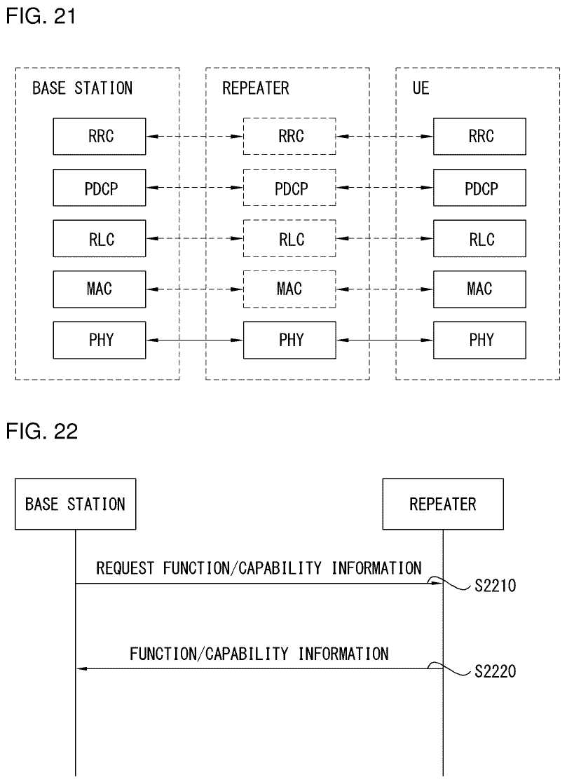

FIG. 21 is a diagram illustrating some of protocol layers of a base station, a repeater, and a UE according to an embodiment of the present disclosure.

Protocol layers for the repeater may include only either a PHY layer or the PHY layer and L2 layers (a MAC layer, an RLC layer, and a PDCP layer), or may include the PHY layer, the L2 layers, and an RRC layer. The base station may transmit the control information through RRC signaling, MAC-CE and/or DCI. Here, the type of the control information and/or the type of a signal to be used by the base station according to the protocol layers of the repeater may be identified. For example, when the protocol layers for the repeater include all of the PHY layer, the L2 layers, and the RRC layer, RRC signaling, MAC-CE or DCI may be used according to the type of information for control information/control signaling of the technical features proposed herein.

For example, in relation to the configuration of control signaling described above, hierarchical signaling may be defined on an assumption that the repeater includes all of the PHY layer, the L2 layers, and the RRC layer. Alternatively, unlike the above description, when the repeater includes only some of the PHY layer, the L2 layers, and the RRC layer, the hierarchical signaling may be transmitted or received through signaling corresponding to some layers included in the repeater.

FIG. 22 is a sequence chart of a procedure for transmitting function/capability information of a repeater according to an embodiment of the present disclosure.

Referring to FIG. 22, a base station may transmit a function/capability request message to the repeater (or the relay) (S2210). The repeater may transmit the information about the function/capability to the base station in response to the message (S2220). Here, the information about the function/capability may be information about a function provided by the repeater, a capability supported by the repeater, or the like. For example, the information about the function/capability may include part of or all information related to various scenarios for the repeater, the configuration of regions of elements of the repeater, a control signaling procedure, and the configuration of the control signaling.

In the procedure of FIG. 22, information may be transmitted or received by RRC signaling similar to a procedure of transmitting or receiving UE capability information by the NR system. Alternatively, information may be transmitted or received by L1 and/or L2 signaling according to protocol layers of the repeater.

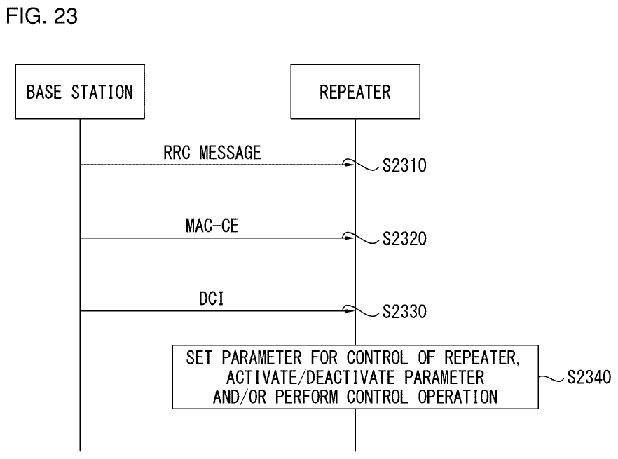

FIG. 23 is a sequence chart of an example of a control signaling procedure of a repeater according to an embodiment of the present disclosure.

Referring to FIG. 23, a base station may transmit RRC signaling to the relay (S2310). Here, the RRC signaling may include all information and/or parameters for control of the repeater. Alternatively, the RRC signaling may include, for example, control information about a higher layer or an upper region of hierarchical signaling.

The base station may transmit MAC-CE to the repeater (S2320). Here, the MAC-CE may instruct the repeater as to whether to activate or deactivate a set parameter through the RRC signaling. In this case, a new LCID may be defined/allocated for the repeater to activate or deactivate the parameter.

The base station may transmit DCI to the repeater (S2330). Here, similar to the MAC-CE, the DCI may instruct the repeater as to whether to activate or deactivate the set parameter through RRC signaling. Alternatively, the DCI may include, for example, control information about a lower layer or a lower region among hierarchical signaling. Alternatively, the DCI may include a parameter for controlling the repeater.

The base station may set a parameter for controlling the repeater, activate or deactivate the parameter, and/or perform a control operation based on part or all of the RRC signaling, the MAC-CE, and the DCI received in operations S2310 to S2330 (S2340). The above-described technical features may be referred to in concrete examples of setting the parameter, activating or deactivating the parameter, and/or performing the control operation.

Meanwhile, not all of the operations described in the example of FIG. 23 are essential elements. Alternatively, according to the protocol layers of the repeater, some of the examples of signaling in the example of FIG. 23 may be replaced with signaling of another layer. Accordingly, some of the operations described above and/or some of the above examples of signaling may be omitted.

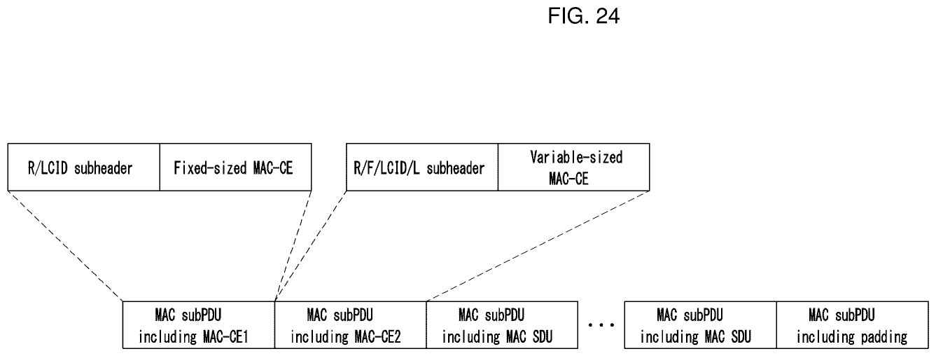

FIG. 24 is a diagram illustrating an example of a MAC-CE applicable to the technical features proposed in the present disclosure.

In the existing LTE system, a MAC sub-header may be located at the start of an LTE MAC PDU. Referring to FIG. 24, the NR MAC sub-header may be located directly before a corresponding SDU or payload. That is, in the LTE system, the MAC sub-header and data corresponding thereto may be located in different regions, whereas in the NR system, the MAC sub-header and corresponding data or payload may be located next to each other, i.e., in the same region.

As described above, an existing LCID may be used for MAC-CE for control signaling proposed herein or an LCID for a repeater may be defined. For example, an LCID for activation or deactivation of regions of or a set of elements, an LCID for activation or deactivation of the power-on operation or the power-off operation, and the like may be newly defined.

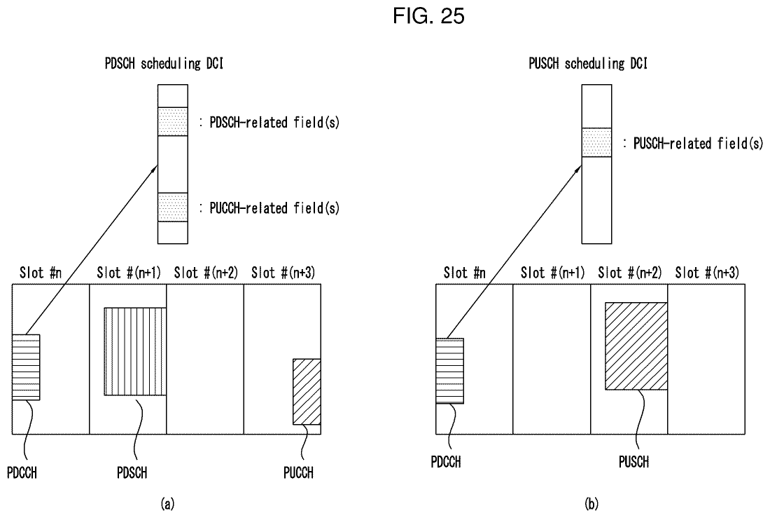

FIG. 25 is a diagram illustrating an example of a DCI applicable to the technical features proposed in the present disclosure.

(a) of FIG. 25 illustrates an example of DCI for scheduling a PDSCH and a PUCCH, and (b) of FIG. 25 illustrates an example of DCI for scheduling a PUSCH.

Similar to the existing NR system, a repeater may receive DCI from a base station through a PDCCH. Here, the DCI may include control information for some or all of the above-described technical features. As described above, a format for the DCI of FIG. 25 may be defined for repeaters such as an NCR and an RIS. The format of the DCI proposed herein may include previously defined DCI formats of the existing NR system (e.g., DCI format 0_0 and/or DCI format 0_1 for uplink scheduling, DCI format 1_0 and/or DCI format 1_1 for downlink scheduling, and the like). When the DCI formats of the existing NR system are used for control signaling of the repeater, a field indicating control information for the repeater may be defined in the DCI formats of the existing NR system.

Referring to (a) of FIG. 25, the repeater may receive DCI. Here, the repeater may receive a PDSCH from the base station on the basis of a PDSCH-related field included in the DCI. Here, the repeater may receive the PDSCH to a UE on the basis of the PDSCH-related field included in the DCI. Here, the PDSCH may include data of the UE that is relayed by the repeater, information related to the repeater, and the like. The repeater may receive the PDSCH on the basis of the PDSCH-related field included in the DCI. Here, the PUCCH may include HARQ-ACK-related information.

Referring to (b) of FIG. 25, the repeater may receive DCI. Here, a PUSCH may be received from the base station on the basis of a PUSCH-related field included in the DCI. The PUSCH may include information related to the capability of the base station, data transmitted from the UE and relayed by the repeater, and the like.

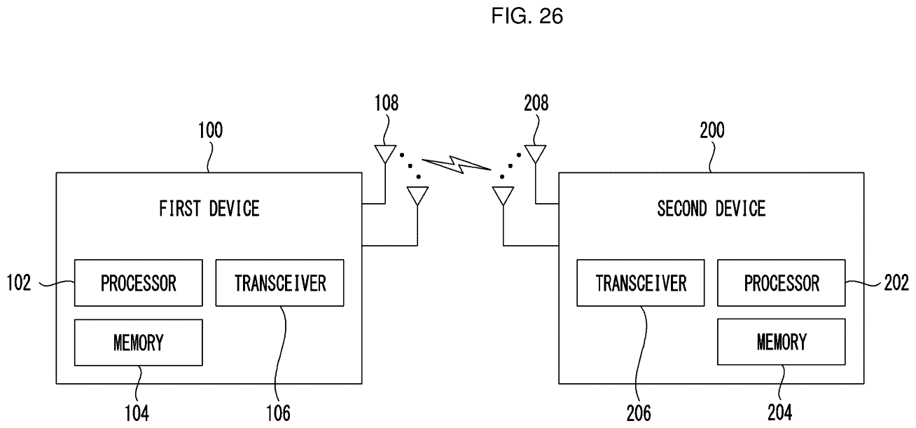

FIG. 26 is a diagram illustrating examples of a wireless device applicable to the present disclosure.

Referring to FIG. 26, a first wireless device 100 and a second wireless device 200 may transmit and receive radio signals through various wireless access technologies (e.g., LTE and NR). Here, {the first wireless device 100 and the second wireless device 200} may correspond to {the base station 1410 and the new type of repeater 1420} of FIG. 14 and/or {the new type of repeater 1420 and the UE 1430} of FIG. 14 and/or {the base station 1510 and the new type of repeater 1520} of FIG. 15 and/or {the new type of repeater 1520 and the UE 1530} of FIG. 15 and/or {the base station 1610 and the new type of repeater 1630} of FIG. 15 and/or {the new type of repeater 1630 and the UE 1650} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. In addition, the one or more processors 102 and 202 may perform control so that the one or more transceivers 106 and 206 may receive user data, control information, or radio signals from one or more other devices. In addition, the one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters.

Meanwhile, the method according to various embodiments of the present disclosure described above may be implemented as a computer-executable program code, and may be provided to each server or device as being stored in various non-transitory computer readable media, so that it can be executed by a processor.

In one example, a program is provided to a device of a repeater to be executed by a processor while stored in a non-transitory readable medium, comprising obtaining control information from a network node and controlling the repeater based on the control information.

The non-transitory readable medium refers to a medium that stores data semi-permanently and can be read by a device, rather than a medium that stores data for a short period of time, such as a register, cache, or memory. Specifically, the various applications or programs described above may be stored and provided on non-transitory readable media such as CD, DVD, hard disk, Blu-ray disk, USB, memory card, ROM, etc.

The claims described herein may be combined in various ways. For example, an apparatus may be implemented from a combination of the technical features of the method claims of the present disclosure, and a method may be implemented from a combination of the technical features of the apparatus claims of the present disclosure. Alternatively, an apparatus may be implemented from a combination of the technical features of the method claims of the present disclosure and the technical features of the apparatus claims of the present disclosure, and a method may be implemented from a combination of the technical features of the method claims of the present disclosure and the technical features of the apparatus claims of the present disclosure.

1. A communication method of a repeater in a wireless communication system, comprising:
receiving control information from a network node; and
controlling the repeater on the basis of the control information.

2. The communication method of claim 1, wherein the control information comprises control information about at least some elements of the repeater.

3. The communication method of claim 2, wherein the control information for the at least some elements of the repeater comprises at least one of information about a configuration of at least one of regions of the elements or a set or group of the elements or information about a function of the regions or the set or group.

4. The communication method of claim 1, wherein the controlling of the repeater comprises at least one of controlling the repeater to be powered on and/or off, controlling an antenna or form of the repeater, beamforming, giving a report to the base station, transmitting control information for a user equipment (UE), or configuring regions or a set of elements of the repeater.

5. The communication method of claim 4, wherein the controlling of the repeater to be powered off comprises maintaining a minimum amount of power necessary to monitor reception of the control information.

6. The communication method of claim 4, wherein the controlling of the repeater to be powered on and/or off is performed on the basis of discontinuous reception (DRX).

7. The communication method of claim 1, wherein the control information is transmitted periodically, quasi-periodically, or aperiodically.

8. The communication method of claim 1, wherein the control information comprises an explicit command or an implicit command.

9. The communication method of claim 1, wherein the repeater comprises a network-controlled repeater (NCR) or a reconfigurable intelligent surface (RIS).

10. A repeater apparatus for performing communication in a wireless communication system, comprising:
a transceiver configured to obtain control information from a network node; and
a processor configured to control the repeater on the basis of the control information.

11. The repeater apparatus of claim 10, wherein the control information comprises control information about at least some elements of the repeater.

12. The repeater apparatus of claim 11, wherein the control information for the at least some elements of the repeater comprises at least one of information about a configuration of regions of the elements or a set or group of the elements or information about a function of the regions or the set or group.

13. The repeater apparatus of claim 10, wherein the processor controls the repeater according to at least one of controlling the repeater to be powered on and/or off, controlling an antenna or form of the repeater, beamforming, giving a report to the base station, transmitting control information for a user equipment (UE), or configuring regions or a set of elements of the repeater.

14. The repeater apparatus of claim 13, wherein the controlling of the repeater to be powered off comprises maintaining a minimum amount of power necessary to monitor reception of the control information.

15. The repeater apparatus of claim 13, wherein the controlling of the repeater to be powered on and/or off is performed on the basis of discontinuous reception (DRX).

16. The repeater apparatus of claim 10, wherein the control information is transmitted periodically, quasi-periodically, or aperiodically.

17. The repeater apparatus of claim 10, wherein the control information comprises an explicit command or an implicit command.

18. The repeater apparatus of claim 10, wherein the repeater comprises a network-controlled repeater (NCR) or a reconfigurable intelligent surface (RIS).

19. A computer-readable recording medium having recorded thereon a program causing a computer to execute operations of a communication method of a repeater in a wireless communication system, wherein the communication method of the repeater comprises:
receiving control information from a network node; and
controlling the repeater on the basis of the control information.

20. The computer-readable recording medium of claim 19, wherein the control information comprises control information about at least some elements of the repeater.
